(19) United States
(12) Patent Application Publication
(10) Pub. No.: US 2014/0143115 A1
(43) Pub. Date: May 22, 2014

(54) RECORDING MEDIUM, INDEX VALUE CALCULATION METHOD, AND INDEX VALUE CALCULATION APPARATUS

(71) Applicant: Ueda Harlow Ltd., Tokyo (JP)

(72) Inventor: Shigeki KONO, Tokyo (JP)

(73) Assignee: Ueda Harlow Ltd., Tokyo (JP)

(21) Appl. No.: 13/954,542

(22) Filed: Jul. 30, 2013

(30) Foreign Application Priority Data
Nov. 16, 2012 (JP) 2012-252710

(51) Int. Cl. G06Q 40/04

(52) U.S. Cl. CPC G06Q 40/04
USPC 705/37

(57) ABSTRACT

A system performs: acquiring historical data in which for each unit period, a high price and a low price of transaction price are related to a start time or an end time of a unit period; identifying the lowest price and the highest price of transaction price from the acquired historical data; acquiring a transaction price at predetermined time intervals; and based on the identified lowest price and highest price and the transaction price, calculating an index value indicating a trend in the transaction price. The system performs: at each time of acquiring the transaction price, based on the acquired transaction price and the identified lowest and highest prices, updating the lowest price or the highest price of transaction price; and based on the updated one of the lowest price and the highest price, the other one not updated, and the acquired transaction price, calculating the index value.

### CROSS-REFERENCE TO RELATED APPLICATIONS

This Nonprovisional application claims priority under 35 U.S.C. §119(a) on Patent Application No. 2012-252710 filed in Japan on Nov. 16, 2012, the entire contents of which are hereby incorporated by reference.

### FIELD

The present invention relates to: a recording medium recording thereon a computer program causing a computer to execute the processing of calculating an index value indicating a trend in the transaction price of a product as well as an order data generating program; and an index value calculation method and an index value calculation apparatus calculating the index value.

### BACKGROUND

In recent years, an on-line trading system has been proposed in which computers of investors are connected to a computer of a financial product broker through communication lines so that the investors are allowed to perform on-line financial transactions such as stock trading, commodity futures trading, and foreign exchange margin trading (Japanese Patent Application Laid-Open No. 2006-260441).

When an investor purchases a financial product at a price as low as possible and then sells it off at a timing that the price has risen, a profit is achieved. Thus, investors try to predict future prices with taking into consideration the past transaction prices of stocks, commodities, and foreign exchanges as well as economic conditions and the like. As a technique of predicting future prices, technical analysis is used. The technical analysis is the technique of analyzing the pattern of price trend in a financial product and thereby predicting and analyzing a future change in the price. Japanese Patent Application Laid-Open No. 2012-27513 discloses a system that performs RSI (Relative Strength Index) analysis serving as a technique in technical analysis and then provides the result.

### SUMMARY

A pivot technique is known as a technique in technical analysis. The pivot technique is a technique in technical analysis and devised by J. W. Wilder. In the pivot technique, a plurality of index values including a pivot value are calculated. In the pivot technique, a price movement range of the day of interest is predicted by using the price of the preceding day. In the pivot technique, the price of the day of interest is predicted from the prices (the high price, the low price, and the closing price) of the preceding day. This technique is suitable for the operation of generating and placing an order of that day on the basis of the data of the preceding day before the market opens and then trying to ensure a profit of the day. Thus, the pivot value is recognized as an index oriented to day trading in which dealing is completed in a short period. Such pivot technique is utilized in stock trading and foreign exchange margin trading (FX trading; FX is an abbreviation of Foreign Exchange).

Nevertheless, with progress in IT technology in recent years, a larger amount of information is allowed to be rapidly acquired. Thus, an increasing demand arises that a profit should be obtained in a short time. Further, when the pivot technique is applied to FX, a high precision is achieved at a timing immediately after NYC (New York Close). Nevertheless, as time progresses, its reliability decreases. Thus, the technique is not frequently used in the afternoon of Tokyo time or after. Here, the New York Close is the time regarded as the end of business day for convenience in foreign exchange markets. That time corresponds to 7:00 a.m. in Japan time. When the U.S. is in the summer time, the time corresponds to 6:00 a.m. in Japan time.

Further, exchange rates vary depending on the economic conditions of the individual countries. Thus, in some cases, a tendency in a market varies large even within the same day before and after the announcement of an economical index. An exemplary situation is considered that U.S. employment statistics (the non-agricultural sector employee number and the unemployment rate) have been announced. In a case that according to the contents of the announcement, the non-agricultural sector employee number has decreased and the unemployment rate has increased from those of the preceding announcement, in some cases, movement of dollar buying in the market is changed drastically into a tendency of dollar selling. In such a situation, the conventional pivot technique is inapplicable which serves as an analytical technique of day-to-day basis.

The present invention has been devised in view of the above-mentioned situation. An object thereof is to provide: a recording medium recording thereon a computer program calculating an index value in accordance with a shorter period than the conventional art as well as an order data generating program; and an index value calculation method and an index value calculation apparatus calculating an index value in accordance with a shorter period than the conventional art.

The computer program according to the present invention is a computer program causing a computer to perform: on the basis of a time of day, a unit period in which a high price and a low price of transaction price of a product are to be calculated, and a calculation period containing a plurality of consecutive unit periods, setting forth an acquisition period for data to be used for calculating an index value indicating a trend in the transaction price; from a historical data storage part storing, historical data in which for each unit period, a high price and a low price of transaction price are related to a start time or an end time of the unit period, reading out historical data contained in the set-forth acquisition period; identifying the lowest price and the highest price of transaction price from the read-out historical data; acquiring a transaction price at predetermined time intervals; and on the basis of the identified lowest price and highest price and the transaction price, calculating the index value indicating the trend in the transaction price, wherein the computer program causes the computer to further perform: at each time of acquiring the transaction price, on the basis of the acquired transaction price and the identified lowest and highest prices, updating the lowest price or the highest price of transaction price; and on the basis of the updated one of the lowest price and the highest price, the other one not updated, and the acquired transaction price, calculating the index value.

According to the present invention, at each time of acquiring the transaction price, the highest price and the lowest price of transaction price are updated and then the index value is calculated. This permits referring to the index value varying at every moment.

The computer program according to the present invention includes: acquiring a time of day together with the transaction price and then, when the acquired time of day is not contained in the acquisition period, updating the acquisition period; reading out historical data contained in the updated acquisition period; identifying the lowest price and the highest price of transaction price from the read-out historical data; and calculating the index value.

According to the present invention, the acquisition period for historical data is changed as time progresses. Thus, the index value based on the newest data is obtained.

The computer program according to the present invention includes calculating the index value P according to the following Formula A.

P=(H+L+PR)/3 (Formula A)

where

PR: transaction price

H: highest price

L: lowest price

According to the present invention, the index value P is such that real-time nature is imparted to that of the conventional pivot technique. Thus, an index value having reliability similar to the conventional pivot technique and real-time nature is obtained. Here, the real-time nature indicates that the index value is calculated always by using the newest data. Since calculation of the index value is performed by using the newest data, a more accurate value is obtained than the conventional pivot technique.

The order data generating program according to the present invention includes: calculating the index value P according to the following Formula A; by using the calculated index value P according to following Formulas B, C, D, E, F, and G, calculating resistance lines R1, R2, and R3 and support lines S1, S2, and S3; and generating fresh order data, profit taking order data, and loss cut order data for the product containing as prices three values selected from R1, R2, R3, S1, S2, S3 and the index value P which have been obtained by calculation.

P=(H+L+PR)/3 (Formula A)

R1=2P−L (Formula B)

R2=P−L+H (Formula C)

R3=2P−2L+H (Formula D)

S1=2P−H (Formula E)

S2=P−H+L (Formula F)

S3=2P−2H+L (Formula G)

where

PR: transaction price

H: highest price

L: lowest price

R1: resistance line 1

R2: resistance line 2

R3: resistance line 3

S1: support line 1

S2: support line 2

S3: support line 3

According to the present invention, prices for fresh order, profit taking order, and loss cut order are allowed to be individually determined by using a plurality of calculated index values. Thus, the three orders are allowed to be performed easily and simultaneously.

The order data generating program according to the present invention includes: for each unit period, reading out the P, R1, R2, R3, S1, S2, and S3 from an index value storage part storing, the P, R1, R2, R3, S1, S2, and S3 in a manner of being related to a start time or an end time of the unit period, and then outputting an image in which the read-out P, R1, R2, R3, S1, S2, S3, an order price contained in an ordinary order, a profit taking price contained in the profit taking order, and a loss cut price contained in the loss cut order are displayed in two-dimensional coordinates; receiving on the image an operation of changing at least one of the order price, the profit taking price, and the loss cut price; and generating fresh order data, profit taking order data, and loss cut order data in which the received contents of changing the price are reflected.

According to the present invention, by operating the order price, the profit taking price, and the loss cut price displayed on the graph of index value, the user is allowed to change the individual values. Thus, adjustment of the individual prices is achieved easily.

The order data generating program according to the present invention includes: receiving an instruction of confirming the fresh order data, the profit taking order data, and the loss cut order data having been generated; imparting an order number to the fresh order data; storing into an order data storage part the fresh order data as well as the profit taking order data and the loss cut order data related to the fresh order data by using the order number; storing an ordering pattern indicating a correspondence relation of the P, R1, R2, R3, S1, S2, and S3 used when the fresh order data as well as the profit taking order data and the loss cut order data related to the fresh order data are generated to the order price, the profit taking price, and the loss cut price, into an ordering pattern storage part in a manner of being related to the order number; reading out fresh order data from the order data storage part; at each time of acquiring the transaction price, judging whether contract has been established for the read-out fresh order data; when establishment of the contract has been concluded, generating position data on the basis of the fresh order data whose contract has been established and then storing into a position storage part the position data in a manner of being related to the order number of the fresh order data whose contract has been established; reading out profit taking order data or loss cut order data from the order data storage part; at each time of acquiring the transaction price, judging whether contract has been established for the profit taking order data or the loss cut order data having been read out; when establishment of the contract has been concluded, on the basis of the order number related to the profit taking order data or the loss cut order data whose contract has been established, reading out position data related to the order number from the position storage part; on the basis of the order number related to the read-out position data, reading out from the ordering pattern storage part an ordering pattern related to the order number; and in accordance with the read-out ordering pattern, generating new fresh order data as well as profit taking order data and loss cut order data related to the fresh order data.

According to the present invention, when contract has been established for the profit taking order or the loss cut order so that the position has been cleared, order data similar to the fresh order, the profit taking order, and the loss cut order corresponding to the cleared position is generated and then an order is placed. This permits repeated placement of a similar order without the necessity of user operation. This order is generated by using an ordering pattern related to the position.

The order data generating program according to the present invention is characterized in that the fresh order data contains a term of validity and by including: when the term of validity of the fresh order data stored in the order data storage part has elapsed, reading out from the order data storage part the fresh order data whose term of validity has elapsed and the profit taking order data and the loss cut order data related to the fresh order data; and on the basis of the order number of the read-out fresh order data, reading out an ordering pattern from the ordering pattern storage part and then, in accordance with the read-out ordering pattern, updating the read-out fresh order data as well as the profit taking order data and the loss cut order data related to the fresh order data.

According to the present invention, a term of validity is set forth for each order. Then, for the order whose term of validity has elapsed, the price is updated in accordance with an ordering pattern related to the order. This increases a possibility that contract is established for the order whose contract is not yet established. This contributes to improvement in the capital turnover efficiency.

The order data generating program according to the present invention is characterized in that the fresh order data contains a term of validity and by including, when the term of validity of the fresh order data stored in the order data storage part has elapsed, deleting from the order data storage part the fresh order data whose term of validity has elapsed and the profit taking order data and the loss cut order data related to the fresh order data.

According to the present invention, each order contains a term of validity. Then, an order whose term of validity has elapsed is deleted so that the user is prompted to place a new order. This contributes to improvement in the capital turnover efficiency.

The order data generating program according to the present invention is characterized in that the position data contains a term of validity and by including, when the term of validity of the position data stored in the position storage part has elapsed, generating a market order for clearing the position data whose term of validity has elapsed.

According to the present invention, a term of validity is set forth for each position. Then, a position whose term of validity has elapsed is cleared by a market order. This contributes to improvement in the capital turnover efficiency.

The order data generating program according to the present invention is characterized in that the position data contains a term of validity and by including: when the term of validity of the position data stored in the position storage part has elapsed, on the basis of the order number related to the position data whose term of validity has elapsed, reading out the profit taking order data and the loss cut order data from the order data storage part and then acquiring a profit taking price contained in the read-out profit taking order data and a loss cut price contained in the read-out loss cut order data; and calculating a difference between the profit taking price and the loss cut price having been acquired, then setting forth an addition value on the basis of the calculated difference, and then, for each predetermined time interval, updating the loss cut order data with adopting as a new loss cut price the price obtained by adding the set-forth addition value to the loss cut price.

According to the present invention, a term of validity is set forth for each position. Then, when the term of validity of a position has elapsed, a difference is calculated between the profit taking price of the profit taking order and the loss cut price of the loss cut order related to the position. Then, on the basis of the obtained difference, an addition value is set forth and then the set-forth addition value is added to the loss cut price at predetermined time intervals. Thus, as time progresses, the possibility increases that clearance of the position is achieved. This contributes to improvement in the capital turnover efficiency.

The index value calculation method according to the present invention is an index value calculation method comprising: on the basis of a time of day, a unit period in which a high price and a low price of transaction price of a product are to be calculated, and a calculation period containing a plurality of consecutive unit periods, setting forth in advance an acquisition period for data to be used for calculating an index value indicating a trend in the transaction price; from a historical data storage part storing, historical data in which for each unit period, a high price and a low price of transaction price are related to a start time or an end time of the unit period, reading out, in advance, historical data contained in the set-forth acquisition period; identifying in advance the lowest price and the highest price of transaction price from the read-out historical data; acquiring a transaction price at predetermined time intervals; and on the basis of the lowest price, the highest price, and the transaction price, calculating the index value indicating the trend in the transaction price, wherein the index value calculation method further includes: at each time of acquiring the transaction price, on the basis of the acquired transaction price and the identified lowest and highest prices, updating the lowest price or the highest price of transaction price; and on the basis of the updated one of the lowest price and the highest price, the other one not updated, and the acquired transaction price, calculating the index value.

The index value calculation apparatus according to the present invention is an index value calculation apparatus, comprising: an acquisition period determination part, on the basis of a time of day, a unit period in which a high price and a low price of transaction price of a product are to be calculated, and a calculation period containing a plurality of consecutive unit periods, configured to set forth an acquisition period for data to be used for calculating an index value indicating a trend in the transaction price; a historical data acquisition part, from a historical data storage part storing, historical data in which for each unit period, a high price and a low price of transaction price are related to a start time or an end time of the unit period, configured to read out historical data contained in the set-forth acquisition period; a highest price and lowest price identification part configured to identify the lowest price and the highest price of transaction price from the read-out historical data; and a price acquisition part configured to acquire a transaction price at predetermined time intervals, whereby the index value indicating the trend in the transaction price is calculated, wherein the index value calculation apparatus further comprises: an updating part, at each time of acquiring the transaction price, on the basis of the acquired transaction price and the identified lowest and highest prices, configured to update the lowest price or the highest price of transaction price; and a calculation part, on the basis of the updated one of the lowest price and the highest price, the other one not updated, and the acquired transaction price, configured to calculate the index value.

According to the present invention, at each time of acquiring the transaction price, the highest price and the lowest price of transaction price are updated and then the index value is calculated. Thus, the index value in which the newest transaction price is reflected is obtained.

The above and further objects and features of the invention will more fully be apparent from the following detailed description with accompanying drawings.

### BRIEF DESCRIPTION OF THE DRAWINGS

FIG. 1 is a configuration diagram illustrating an example of a financial product trading system according to Embodiment 1.

FIG. 2 is a block diagram illustrating an example of a hardware configuration of an index value calculation apparatus.

FIG. 3 is a block diagram illustrating an example of a hardware configuration of a financial product transaction management apparatus.

FIG. 4 is a block diagram illustrating an example of a functional block diagram of an index value calculation apparatus.

FIG. 5 is a diagram illustrating an example of a record layout of a historical data table.

FIG. 6 is a diagram illustrating an example of a record layout of an order data table.

FIG. 7 is a diagram illustrating an example of a record layout of a position data table.

FIG. 8 is a diagram illustrating an example of a record layout of a contract history table.

FIG. 9 is a diagram illustrating an example of an hourly chart.

FIG. 10 is a flow chart illustrating processing of calculating a pivot value.

FIG. 11 is a diagram illustrating an example of a record layout of a pivot value storage table.

FIG. 12 is a graph illustrating pivot values.

FIG. 13 is a flow chart illustrating order processing.

FIG. 14 is a flow chart illustrating order processing.

FIG. 15 is a diagram illustrating an example of an ordering screen.

FIG. 16 is a diagram illustrating an example of an order confirmation screen.

FIG. 17 is a diagram illustrating an example of an ordering screen according to Embodiment 2.

FIG. 18 is a flow chart illustrating initial setting processing for an ordering screen.

FIG. 19 is a diagram illustrating an example of a setting screen.

FIG. 20 is a diagram illustrating an example of an ordering screen according to Embodiment 4.

FIG. 21 is a diagram illustrating an example of a record layout of an order data table according to Embodiment 5.

FIG. 22 is a flow chart illustrating order update or cancellation processing based on a term of validity.

FIG. 23 is a diagram illustrating an example of a record layout of an ordering pattern table.

FIG. 24 is a flow chart illustrating price update processing.

FIG. 25 is a flow chart illustrating clearing order update processing.

### DETAILED DESCRIPTION

The present invention is described below in detail with reference to the drawings illustrating the embodiments. The flowing description is given for foreign exchange serving as an example of a financial product. However, employable applications are not limited to this. That is, the present technique may be applied to stocks, commodity futures, or the like. Further, an example is adopted that the index to be calculated is a real-time pivot value. However, employable indices are not limited to this. That is, similar approach may be applied to other technical indices. The real-time pivot value indicates an index obtained by imparting real-time nature to the conventional pivot technique.

### Embodiment 1

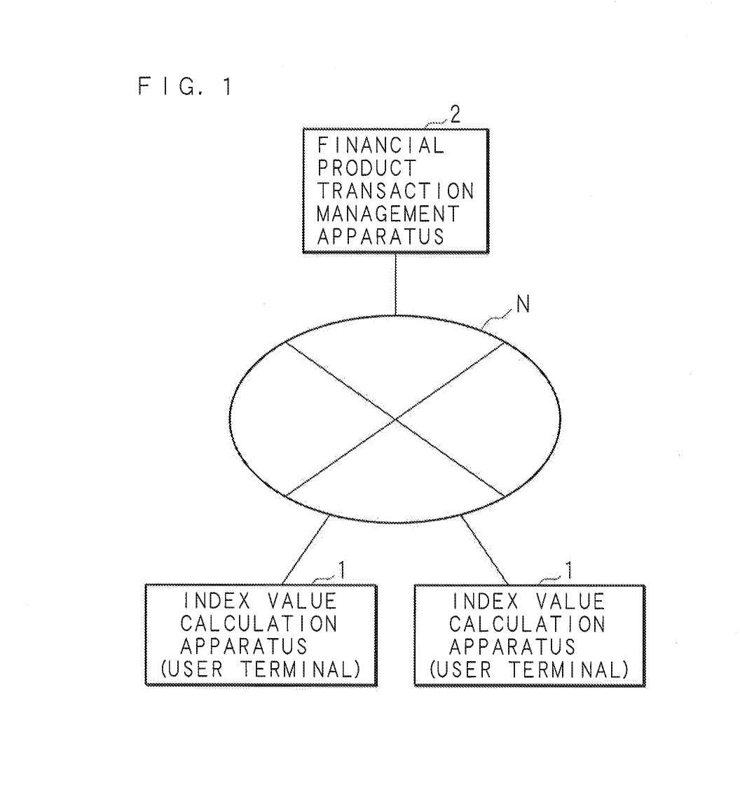

FIG. 1 is a configuration diagram illustrating an example of a financial product trading system according to Embodiment 1. The financial product trading system includes: an index value calculation apparatus (a user terminal) 1; a financial product transaction management apparatus 2; and a communication network N connecting the index value calculation apparatus 1 and the financial product transaction management apparatus 2 with each other. The index value calculation apparatus 1 may be constructed from a personal computer, a portable phone terminal, a smart phone, a PDA (Personal Digital Assistant), or the like. The financial product transaction management apparatus 2 may be constructed from a server computer, a personal computer, or the like. The communication network N may be the Internet, a LAN (Local Area Network), a public telephone network, or the like.

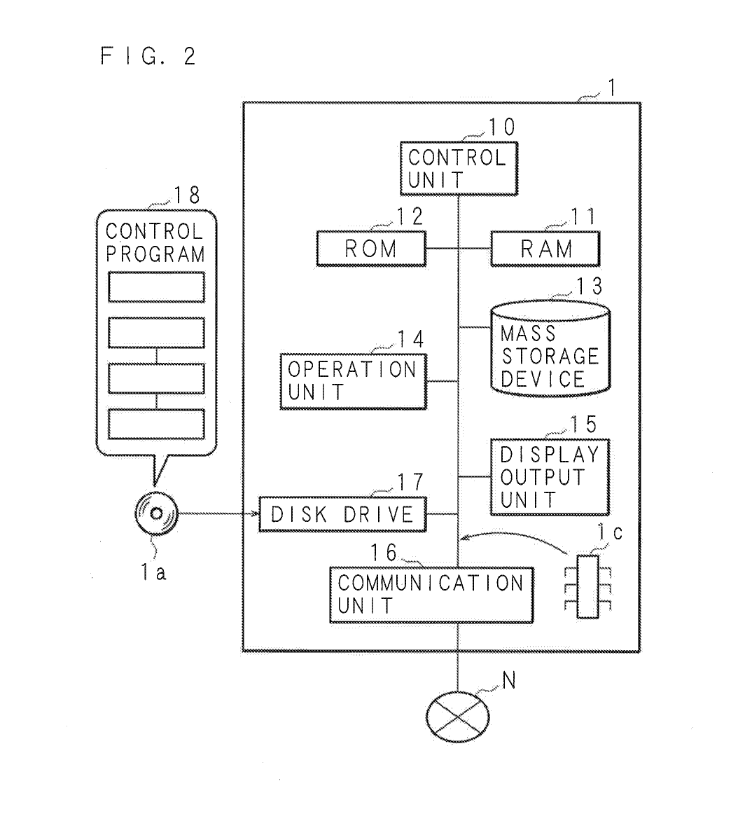

FIG. 2 is a block diagram illustrating an example of the hardware configuration of the index value calculation apparatus 1. The index value calculation apparatus 1 includes a control unit 10, a RAM (Random Access Memory) 11, a ROM (Read Only Memory) 12, a mass storage device 13, an operation unit 14, a display output unit 15, a communication unit 16, and a disk drive 17.

The disk drive 17 reads out information from an external recording medium 1a. For example, the recording medium 1a is composed of a CD, a DVD, or a BD, and records thereon in advance a control program 18 to be executed by the control unit 10. The control unit 10 is composed of a CPU (Central Processing Unit), an MPU (Micro Processor Unit), or the like. The control unit 10 reads out the control program 18 recorded on the recording medium 1a, then loads the program onto the RAM 11 at a suitable time, and thereby executes the program so as to controls the individual units described above. By virtue of this, a general-purpose computer is allowed to operate as the index value calculation apparatus 1.

The RAM 11 is composed of an SRAM (Static RAM), a DRAM (Dynamic RAM), a flash memory, or the like. The RAM 11 temporarily stores various kinds of data generated by the control unit 10 during the execution of various kinds of programs.

The ROM 12 is composed of a nonvolatile memory such as an EEPROM (Electrically Erasable and Programmable ROM) and a flash memory. The ROM 12 stores various kinds of data in advance.

The mass storage device 13 is composed of a hard disk or a flash disk. The mass storage device 13 stores various kinds of data necessary in index value calculation.

The operation unit 14 is composed of a keyboard, a mouse, and the like through which the user performs various kinds of input. The display output unit 15 outputs image data to be displayed on a display device (not illustrated). The communication unit 16 performs communication with the financial product transaction management apparatus 2 through the communication network N. The above-mentioned control program 18 may be stored in the ROM 12 or the mass storage device 13. Further, a semiconductor memory 1c such as a flash memory storing the control program 18 may be incorporated in the index value calculation apparatus 1.

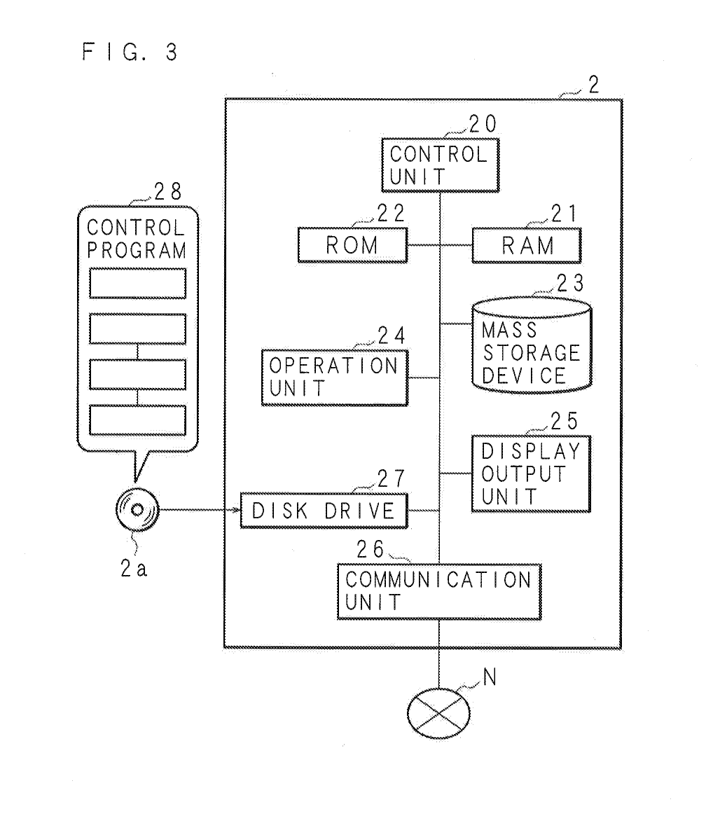

FIG. 3 is a block diagram illustrating an example of the hardware configuration of the financial product transaction management apparatus 2. The financial product transaction management apparatus 2 includes a control unit 20, a RAM 21, a ROM 22, a mass storage device 23, an operation unit 24, a display output unit 25, a communication unit 26, and a disk drive 27.

The disk drive 27 reads out information from an external recording medium 2a. For example, the recording medium 2a is composed of a CD, a DVD, or a BD, and records thereon in advance a control program 18 to be executed by the control unit 20. The control unit 20 is composed of a CPU, an MPU, or the like. The control unit 20 reads out the control program 28 recorded on the recording medium 2a, then loads the program onto the RAM 21 at a suitable time, and thereby executes the program so as to controls the individual parts described above. By virtue of this, a general-purpose computer is allowed to operate as the financial product transaction management apparatus 2.

The RAM 21 is composed of an SRAM, a DRAM, a flash memory, or the like. The RAM 21 temporarily stores various kinds of data generated by the control unit 20 during the execution of various kinds of programs.

The ROM 22 is composed of a nonvolatile memory such as an EEPROM and a flash memory. The ROM 22 stores various kinds of data in advance.

The mass storage device 23 is composed of a hard disk or a flash disk. The mass storage device 23 stores various kinds of data necessary in index value calculation.

The operation unit 24 is composed of a keyboard, a mouse, and the like through which the user performs various kinds of input. The display output unit 25 outputs image data to be displayed on a display device (not illustrated). The communication unit 26 performs communication with the index value calculation apparatus 1 through the communication network N. The above-mentioned control program 28 may be stored in the ROM 22 or the mass storage device 23.

In the financial product transaction management apparatus 2, the mass storage device 23 stores the master data of historical data, order data, position data, and contract history. The financial product transaction management apparatus 2 transmits data for each user through the communication network N to each index value calculation apparatus 1. On the basis of the order data, the financial product transaction management apparatus 2 performs contract of an order, clearing of a position, and the like. The results of contract and clearing are reflected on the order data, the position data, and the contract history data. When the reflected data is transmitted to the index value calculation apparatus 1, the index value calculation apparatus 1 is allowed to recognize that contract has been established for the order or alternatively the position has been cleared. Further, the financial product transaction management apparatus 2 manages all of the orders and the positions of each user. Then, in accordance with the orders and the positions, the financial product transaction management apparatus 2 performs communication with a computer of an inter-bank market (a bank), and thereby performs order processing suitably. Further, with reference to presented prices obtained from the inter-bank market (the bank), the financial product transaction management apparatus 2 sets forth the transaction price.

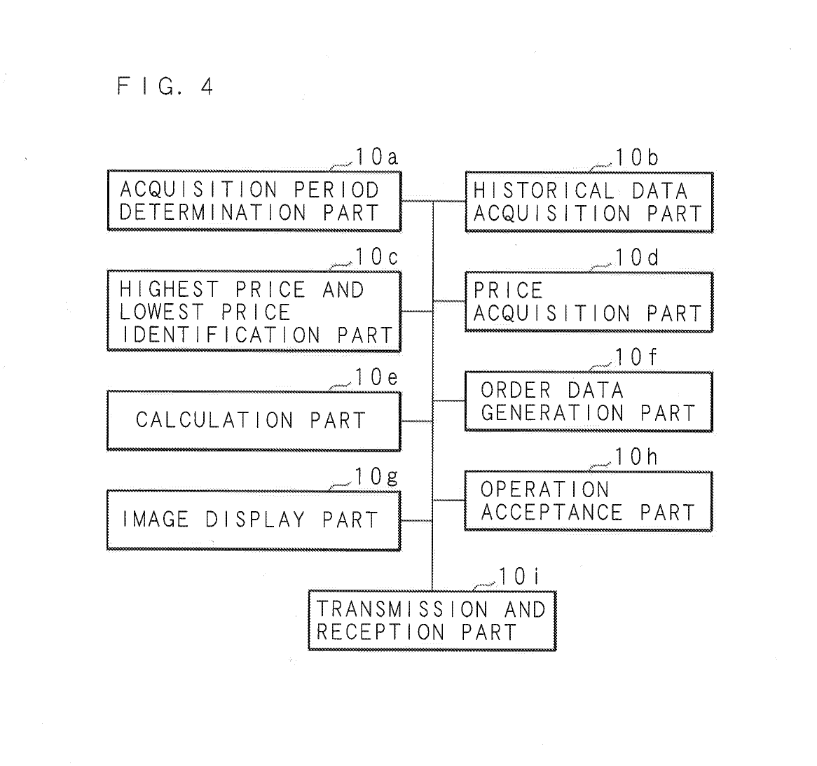

FIG. 4 is a block diagram illustrating an example of a functional block diagram of the index value calculation apparatus 1. When the control unit 10 operates on the basis of the control program 18 recorded on the recording medium 1a, the individual functional parts in FIG. 4 are executed.

On the basis of a time of day, a unit period in which a high price and a low price of transaction price of a product are to be calculated, and a calculation period containing a plurality of consecutive unit periods, the acquisition period determination part 10a sets forth an acquisition period for data to be used for calculating an index value indicating a trend in the transaction price.

From the historical data storage part storing, historical data in which for each unit period, a high price and a low price of transaction price are related to a start time or an end time of the unit period, the historical data acquisition part 10b reads out historical data contained in the set-forth acquisition period. The period in which historical data is to be read out is set forth by the acquisition period determination part 10a.

The highest price and lowest price identification part 10c identifies the lowest price and the highest price of transaction price from the read-out historical data.

The price acquisition part 10d acquires a transaction price at predetermined time intervals. The minimum for the time interval is the shortest tick unit. The tick indicates each proposed rate or update of the proposed rate. The shortest tick unit indicates the shortest value of the time intervals between consecutive ticks. For example, the shortest tick unit is 100 ms. Contract of each order is performed by the tick unit.

At each time of acquiring the transaction price, on the basis of the acquired transaction price as well as the identified lowest price and highest price, the calculation part 10e updates the lowest price or the highest price of transaction price. Then, on the basis of the updated one of the lowest price and the highest price, the other one not updated, and the acquired transaction price, the calculation part 10e calculates the index value.

On the basis of the index value calculated by the calculation part 10e, an order data generation part 10f sets forth the order price and then generates the order data. An image display part 10g generates an image obtained by plotting into a graph the transaction price, the index value calculated by the calculation part 10e, the attention price in the order data generated by the order data generation part 10f, and the like. Then, the image display part 10g outputs the image onto a display device (not illustrated). The operation acceptance part 10h accepts an operation from the operation unit 14 composed of a keyboard, a mouse, a tablet, a touch panel, or the like. The transmission and reception part 10i is a function realized by cooperation between the control unit 10 and the communication unit 16. The transmission and reception part 10i transmits and receives various kinds of data to and from the financial product transaction management apparatus 2.

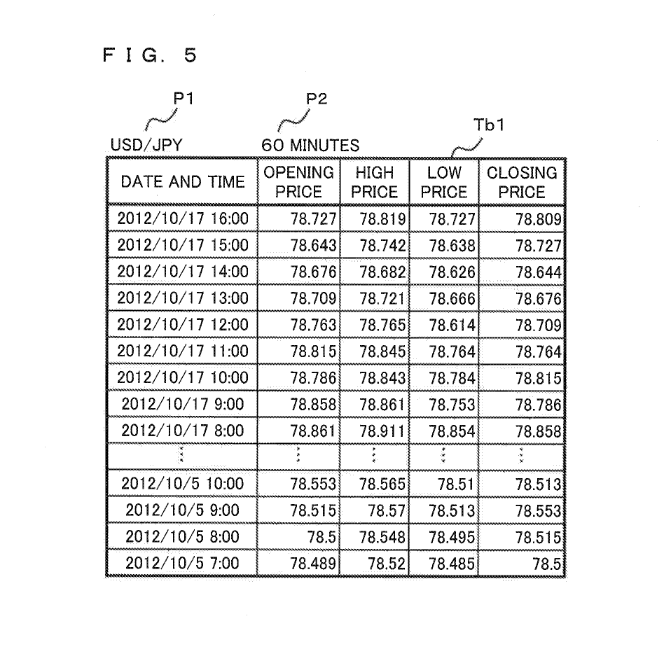

The following description is given for the data stored in the mass storage device 13 of the index value calculation apparatus 1. FIG. 5 is a diagram illustrating an example of record layout of a historical data table Tb1 (a historical data storage part). The historical data table Tb1 contains a date and time field, an opening price field, a high price field, a low price field, and a closing price field. Further, the currency pair P1 and the period P2 are included as attributes. The date and time field stores the date and time, and stores the start date and time of each historical data record. The opening price field stores the transaction price at the start date and time of each historical data record. The high price field stores the highest transaction price within the period of each historical data record. The low price field stores the lowest transaction price within the period of each historical data record. The closing price field stores the transaction price at the end date and time of each historical data record. Here, in place of the opening date and time of historical data record, the date and time field may store the end date and time.

FIG. 5 illustrates data whose currency pair is dollar-yen (USD/JPY) and whose period (unit period) is 1 hour, that is, hourly data of dollar-yen. The first line illustrates that in the period of 16:00 to 16:59 on Oct. 17, 2012, the opening price, i.e., the transaction price at 16:00, was 78.727. Further, it is illustrated that the high price, i.e., the highest transaction price in the period, was 78.819. The low price, i.e., the lowest transaction price in the period, was 78.727 and the closing price, i.e., the transaction price at 16:59, was 78.809. The following description is given for a case that the currency pair is dollar-yen. However, the situation is similar to other currency pairs. The historical data is acquired from other server computer such as the financial product transaction management apparatus 2 by the control unit 10 through the communication unit 16, and then stored into the historical data table Tb1.

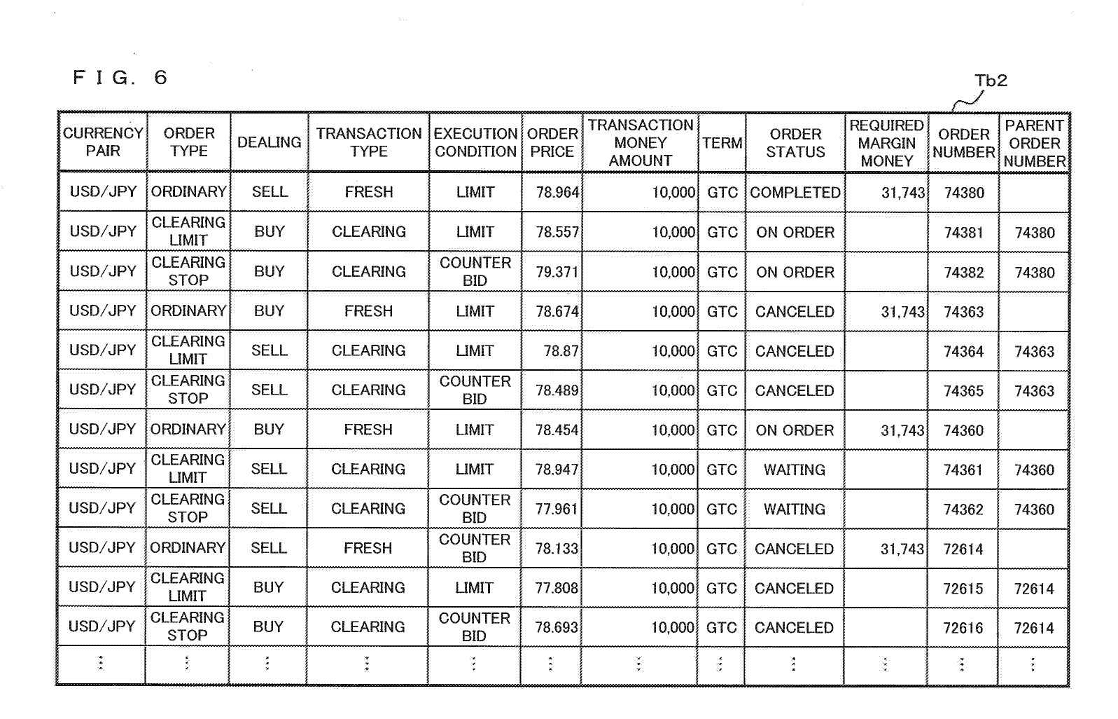

FIG. 6 is a diagram illustrating an example of record layout of an order data table Tb2 (an order data storage part). The order data table Tb2 includes a currency pair field, an order type field, a dealing field, a transaction type field, an execution condition field, an order price field, a transaction money amount field, a term field, an order status field, a required margin money field, an order number field, and a parent order number field.

The currency pair field stores a currency pair corresponding to the order. The data is stored in the form of currency code/currency code. The currency code is an abbreviation of a currency consisting of three alphabetical characters. Examples include USD (U.S. dollar), JPY (Japanese yen), GBP (British pound), and EUR (Euro). In the description of a currency pair, the currency written on the left of the slash (/) is referred to as a transaction currency or key currency. The currency written on the right of the slash is referred to as a relative currency or clearing currency. In FX trading, trading is performed in the transaction currency. Thus, when clearing is to be performed so that the profit and loss is to be paid, the payment is performed in the clearing currency. For example, in USD/JPY, U.S. dollar is bought with Japanese yen. Then, clearing is achieved when U.S. dollar is sold and Japanese yen is bought so that the profit and loss is calculated.

The order type field stores an order type. Order types include “ordinary”, “clearing limit”, and “clearing stop”. An order (an ordinary order) whose order type is “ordinary” is such that on completion of the input, contract thereof is waited. An order (a profit taking order) whose order type is “clearing limit” and an order (a loss cut order, a stop loss order) whose order type is “clearing stop” are linked to an ordinary order. An ordinary order to which linkage is established is referred to as a parent order. A profit taking order and a loss cut order are inputted simultaneously to a parent order, but do not immediately go into an on-order status and do go into a waiting state first. When contract has been established for the parent order, the profit taking order and the loss cut order go into an on-order status from the waiting state. The profit taking order is an order used for setting a profit. The loss cut order is an order used for setting a loss. When any one of the profit taking order and the loss cut order is completed, the other order is automatically canceled.

The dealing field stores a dealing type, which is “sell” or “buy”. For example, when the currency pair is USD/JPY, “sell” indicates that U.S. dollar is to be sold and yen is to be bought. The type “buy” indicates that U.S. dollar is to be bought with yen.

The transaction type field stores a transaction type. Transaction types include “fresh”, “clearing”, and “delivery”. The type “fresh” indicates an order used for acquiring a position newly. The type “clearing” indicates an order used for setting the profit and loss of a position owned. The type “delivery” indicates an order used for receiving a particular currency in the form of other currency.

The execution condition field stores a condition for completing an order. The condition “limit (order)” indicates an order in which a more favorable price (a price in which a profit is obtained) than the transaction price at the time of order is specified. The condition “counter bid” indicates an order in which a more disadvantageous price (price out of which the loss comes) than the price at the time of order is specified.

The order price field stores an order price. The transaction money amount field stores a transaction money amount in terms of clearing currency. The term field stores the term of an order. The term is GTC (Good Till Cancel) or DAY. GTC indicates that the term is limitless. That is, the order remains effective unless the order is completed or is canceled by the user. DAY indicates that the order is effective during that day alone. Thus, an order not yet completed at the end of the day is automatically canceled. Here, the expression “the end of the day” indicates the time NYC when New York Stock Exchange closes (corresponding to 7:00 a.m. in Japan time and to 6:00 a.m. during the summer time in the U.S.).

The order status field stores an order status. Order statuses include “completed”, “on order”, “waiting”, “canceled”, and “expired”. The status “completed” indicates an order having been completed. The status “on order” indicates an order waiting for completion. The status “waiting” indicates an order to be activated when contract has been established for a parent order thereof. The status “canceled” indicates an order having been canceled by an operation of the user before the completion of the order. The status “expired” indicates an order having been automatically canceled because of not having been completed by the end of the term.

The required margin money field stores the amount of margin money required for the fresh order. The amount of margin money is calculated by multiplying the transaction price (the notional capital) by a fixed rate. The required margin money is calculated in real time in correspondence to fluctuation in the foreign exchange rate such that the amount of required margin money is always maintained at a value obtained by multiplying the transaction price (the notional capital) by the fixed rate.

The order number field stores an order number. The order number uniquely specifies each order and is generated by the index value calculation apparatus 1 or the financial product transaction management apparatus 2. The parent order number field stores a parent order number. The parent order number is stored only for a profit taking order and a loss cut order described above.

The order data is generated by the control unit 10 when the user performs an ordering operation, and is then stored into the order data table Tb2. Further, the control unit 10 transmits the order data through the communication unit 16 to the financial product transaction management apparatus 2. Here, the order data stored in the financial product transaction management apparatus 2 should be regarded as master data. Thus, in place of the processing that the order data generated by the control unit 10 is directly stored into the order data table Tb2 of the index value calculation apparatus 1, a new order data may be stored by establishing synchronization with the order data table Tb2 stored in the mass storage device 23 of the financial product transaction management apparatus 2.

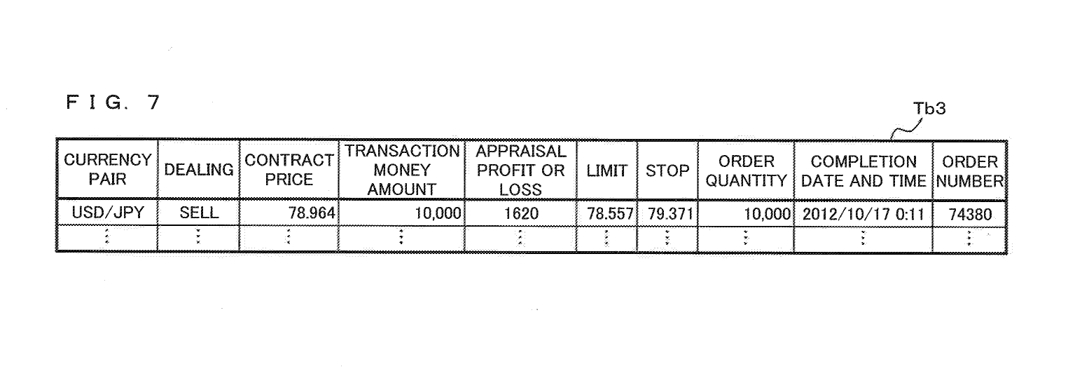

FIG. 7 is a diagram illustrating an example of a record layout of a position data table Tb3 (a position storage part). The position data table Tb3 includes a currency pair field, a dealing field, a contract price field, a transaction money amount field, an appraisal profit or loss field, a limit field, a stop field, an order quantity field, a completion date and time field, and an order number field. The currency pair field stores a currency pair. The dealing field stores whether the order having caused the completion was a selling order or a buying order. When it was a selling order, “sell” is stored. When it was a buying order, “buy” is stored.

The contract price field stores the contract price of an original order. The transaction money amount field stores the transaction money amount of the original order. The appraisal profit or loss field stores the amount of profit or loss calculated on the basis of the present price and the contract price. The limit field and the stop field store individual order prices when the order is related to a profit taking order and a loss cut order corresponding to the position. The order quantity field stores an order quantity when the order is related to a profit taking order and a loss cut order. The completion date and time field stores the date and time of the occasion that contract has been established for an original order so that the position has been established. The order number field stores the order number of an original order.

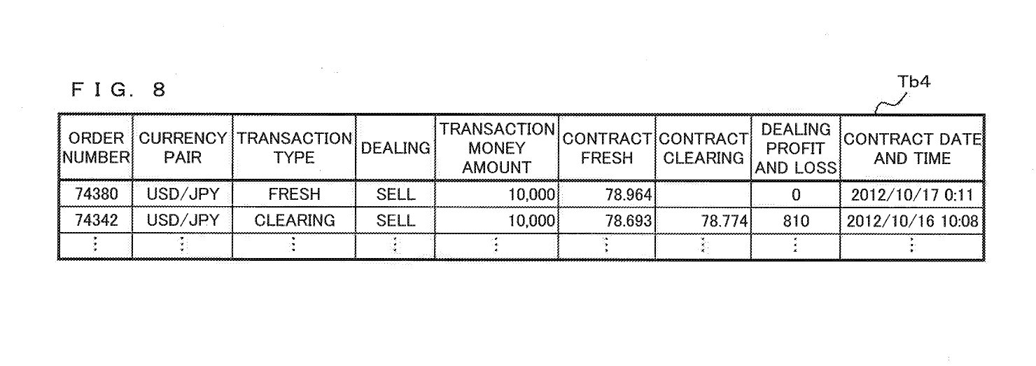

FIG. 8 is a diagram illustrating an example of a record layout of a contract history table Tb4. The contract history table Tb4 includes an order number field, a currency pair field, a transaction type field, a dealing field, a transaction money amount field, a contract fresh field, a contract clearing field, a dealing profit and loss field, and a contract date and time field. The order number field stores the order number of a contract order. The currency pair field stores the currency pair of the contract order. The transaction type field stores the contract order type. When the contract order is of a fresh order, “fresh” is stored. When the contract order is of a clearing order, “clearing” is stored. The dealing field stores the dealing type of the contract order. In case of a selling order, “sell” is stored. In case of a buying order, “buy” is stored. The transaction money amount field stores the transaction money amount of the contract order. The contract fresh field, when the contract order is of fresh, stores the contract price of the contract order. When the contract order is of clearing, the contract fresh field stores the contract price of an order serving as the source of the clearing order. The contract clearing field, only when the contract order is of clearing, stores the clearing price of the clearing order. The dealing profit and loss field, when the contract order is of clearing, stores the amount of dealing profit and loss having been achieved. The dealing profit and loss field stores 0 when the contract order is of fresh. The contract date and time field stores the date and time of completion of the contract order.

The contract and clearing processing is performed by the financial product transaction management apparatus 2. Thus, the master data of the contract history table Tb4 is stored in the mass storage device 23 of the financial product transaction management apparatus 2. The control unit 10 acquires the master data of the contract history table Tb4 from the financial product transaction management apparatus 2 through the communication unit 16 so that synchronization is achieved with the contract history table Tb4 stored in the mass storage device 13.

Next, description is given for the real-time pivot value which is an index value proposed in the present specification. In the real-time pivot technique, the pivot value is calculated from the high price and the low price in the newest specified range (a calculation period width) and from the present price. The specified range sets forth a range indicating how far the data is to be traced back and acquired for the purpose of calculation of the pivot value. For example, the range is 30 minutes, 1 hour, 4 hours, 8 hours, 16 hours, 24 hours, 36 hours, or 48 hours. The high price and the low price in the specified range are obtained from candlestick chart data. The candlestick chart data is the data of four values (the opening price, the closing price, the high price, and the low price) stored for each predetermined period. In general, daily data is often used in which the predetermined period (the time unit) is set to be one day. In the real-time pivot technique, data of shorter period than one day is employed like 1-hour data, 30-minute data, and 1-minute data. In the 1-hour data, each period starts at 0 minute past the hour and ends at 59 minutes past the hour. In the 30-minute data, each period starts at 0 minute past the hour and ends at 29 minutes past the hour or alternatively starts at 30 minutes past the hour and ends at 59 minutes past the hour. In the 1-minute data, each period starts at 0 second past the minute and ends at 59 seconds past the minute.

The combination of the specified range and the historical data may be arbitrary. However, their balance is important. That is, a combination between a wide specified range and historical data of short predetermined period results in an excessively large amount of data to be referred to. That is, such a combination causes a meaningless increase in the amount of calculation. A combination between a narrow specified range and historical data of long predetermined period results in an excessively small amount of data to be referred to. This reduces accuracy. Taking these situations into consideration, for example, when the specified range is set to be 24 hours, 24 pieces of 1-hour data is employed. When the specified range is set to be 12 hours, 24 pieces of 30-minute data is employed. When the specified range is set to be 24 minutes, 24 pieces of 1-minute data is employed. These combinations are exemplary. Thus, when the specified range is set to be 24 hours, 48 pieces of 30-minute data may be employed or alternatively 12 pieces of 2-hour data may be employed. The present embodiment is described below for a case that the specified range is set to be 24 hours and the predetermined period is set to be 1 hour, that is, a case that the pivot value is calculated by using 24 pieces of 1-hour data.

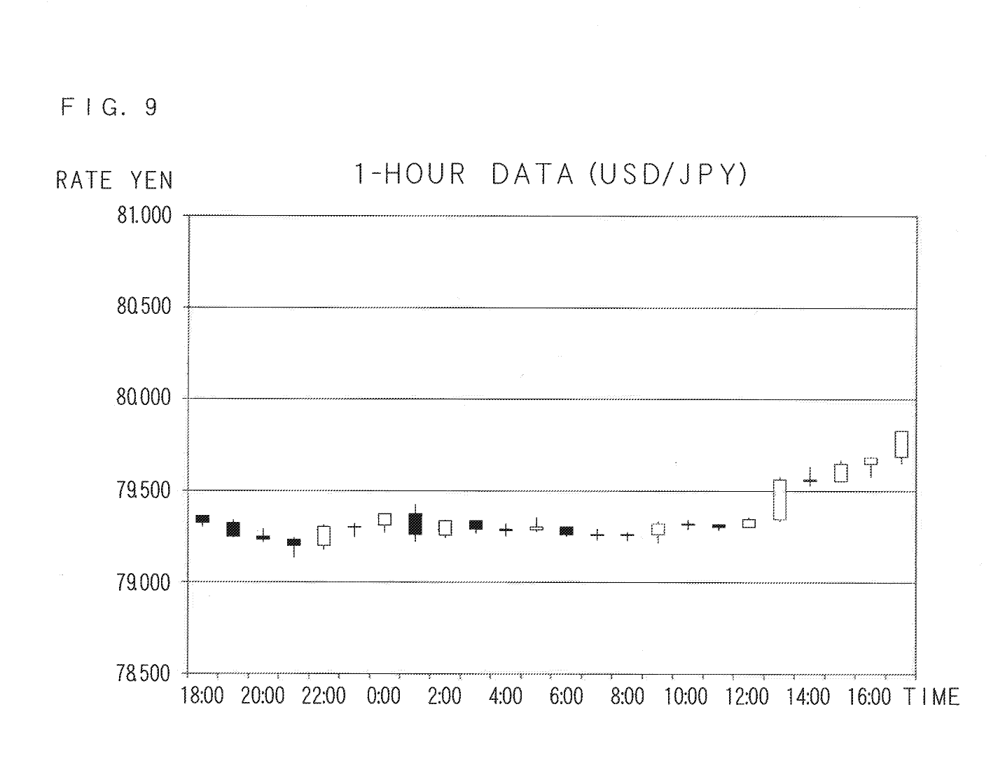

FIG. 9 is a diagram illustrating an example of an hourly chart. The horizontal axis indicates the time of day and the vertical axis indicates the foreign exchange rate (the transaction price). This diagram illustrates the four values (the opening price, the closing price, the high price, and the low price) for each hour. The lower side and the upper side of each quadrangle (referred to as a body) indicate the opening price and the closing price. A white body indicates a situation that the closing price is higher than the opening price (referred to as a positive candle). A black body indicates a situation that the closing price is lower than the opening price (referred to as a negative candle). Straight lines (referred to as whiskers) extending from the body indicate the high price and the low price. In FIG. 9, the start time is adopted as the time of day of each candlestick. That is, the candlestick corresponding to the time of day of 16:00 illustrates the four values in the period from 16:00 to 16:59. FIG. 9 illustrates a chart displayed between 17:00 and 18:00 of one day. The candlestick illustrated in the rightmost part of FIG. 9 is not yet completed. Thus, the present price is temporarily adopted as the closing price so that the four values are determined and the candlestick is illustrated. In accordance with the fluctuation of the present price, the high price and the low price are updated when necessary.

In the present embodiment, the pivot value is calculated by using 24 pieces of 1-hour data. Thus, the pivot value is calculated by using 23 pieces of data from 18:00 of the preceding day to 16:00 of this day illustrated in FIG. 9 and by using the data of 17:00 not yet completed.

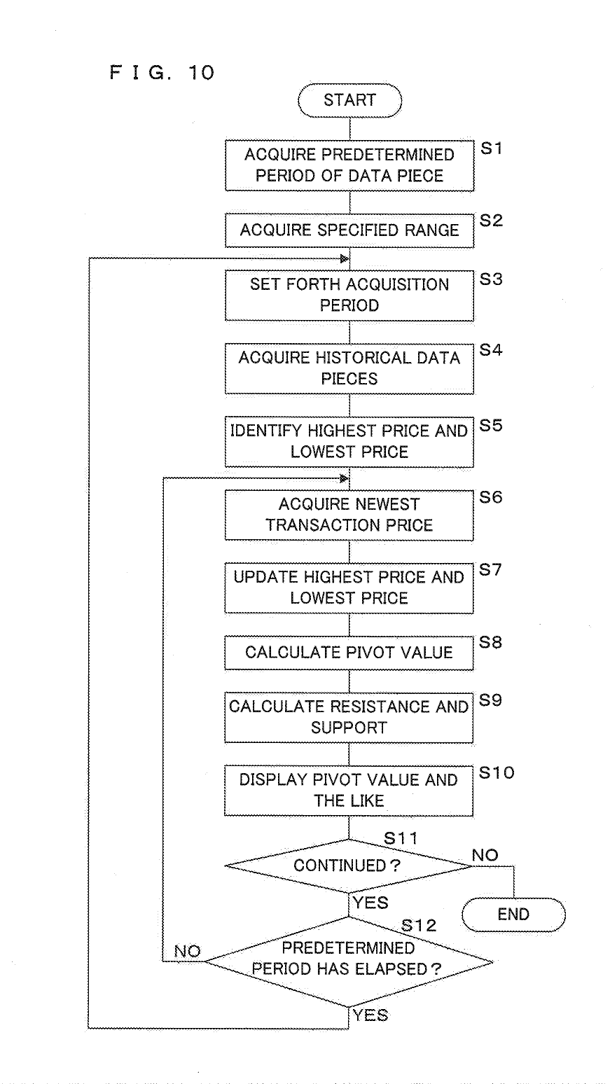

FIG. 10 is a flow chart illustrating the processing of calculating the pivot value. The control unit 10 of the index value calculation apparatus 1 acquires a predetermined period of data piece used for calculating the pivot value and the like (S1). In this example, the predetermined period is 1 hour. The predetermined period may be acquired as a value stored in advance in the ROM 12 or the mass storage device 13, or alternatively may be specified through the operation unit 14 by the user. The control unit 10 acquires a specified range for the data (S2). In this example, the specified range is 24 hours. Similarly to the predetermined period, the specified range may be acquired as a value stored in advance, or alternatively may be specified through the operation unit 14 by the user. Further, combinations of a predetermined period and a specified range may be set forth in advance. Then, any one of a period value and a range value may be acquired so that the other value may be set forth. The control unit 10 acquires the time of day from a clock unit (not illustrated) or a time server in the outside and then sets forth the acquisition period for the data piece on the basis of the time of day, the predetermined period, and the specified range having been acquired (S3).

From the historical data table Tb1 stored in the mass storage device 13, the control unit 10 acquires historical data pieces contained in the acquisition period (S4). On the basis of the high price and the low price in each predetermined period contained in the acquired historical data, the control unit 10 identifies the highest price and the lowest price (S5). The control unit 10 acquires the newest transaction price (S6). The control unit 10 compares the acquired transaction price with the highest price and the lowest price identified at S5 and then updates the highest price and the lowest price when necessary (S7). That is, when the transaction price exceeds the highest price, the highest price is updated to the transaction price. When the transaction price is lower than the lowest price, the lowest price is updated to the transaction price. The control unit 10 calculates the pivot value and the like (S8). The highest price is denoted by H, the lowest price is denoted by L, and the acquired transaction price is denoted by PR. Then, the pivot value P is calculated according to the following Formula A. By using the obtained pivot value P, resistances R1, R2, and R3 and supports S1, S2, and S3 are calculated according to the following Formulas B, C, D, E, F, and G (S9).

P=(H+L+PR)/3 (Formula A)

R1=2P−L (Formula B)

R2=P−L+H (Formula C)

R3=2P−2L+H (Formula D)

S1=2P−H (Formula E)

S2=P−H+L (Formula F)

S3==2P−2H+L (Formula G)

At a glance, Formula A has no difference from the conventional pivot formula. However, as described above, the highest price H and the lowest price L are the highest price and the lowest price in the newest several hours in place of the highest price and the lowest price of the preceding day in the conventional pivot technique. Further, PR is the newest transaction price rather than the closing price of the preceding day in the conventional pivot technique. As such, when the pivot value is calculated, different values are employed so that the newest data is utilized. This realizes the pivot technique having real-time nature that near future is predicted. Further, at a glance, the formulas calculating the resistances and the supports are also similar to those of the conventional pivot technique. However, both the resistances and the supports are calculated by using the pivot value P having real-time nature. Further, the highest price H and the lowest price L are also set forth by the method different from the conventional one. Thus, the resistances and the supports have real-time nature in contrast to the conventional pivot technique. Here, the resistance R3 in this description corresponds to a so-called HBOP (High Break Out Point) in the conventional pivot technique. Similarly, the support S3 corresponds to a so-called LBOP (Low Break Out Point).

The control unit 10 displays the calculated pivot value and the like R1, R2, R3, P, S1, S2, and S3 (S10). The control unit 10 judges whether calculation of the pivot value and the like is to be continued (S11). When the control unit 10 concludes that the calculation is to be continued (YES at S11), the control unit 10 judges whether the predetermined period has elapsed (S12). The expression “the predetermined period has elapsed” indicates that as the time of day progresses, the present time has moved such as to be contained in the next period. For example, in a case that the predetermined period is 1 hour and that the processing start time is 17:26, the predetermined period containing the present time is a period from 17:00 to 17:59. When the time of day progresses into 18:00, the predetermined period containing the present time becomes a period from 18:00 to 18:59, that is, moves to the next period. This situation is referred to by the expression “the predetermined period has elapsed”. When the control unit 10 concludes that the predetermined period has elapsed (YES at S12), the control unit 10 returns the processing to S3. When the control unit 10 concludes that the predetermined period has not yet elapsed (NO at S12), the control unit 10 returns the processing to S6. When the control unit 10 concludes that the calculation is not to be continued (NO at S11), the control unit 10 terminates the processing of calculation.

Here, at the time of acquiring the historical data at S6, all historical data pieces contained in the acquisition period are acquired at the first time. However, at the second and subsequent times, the newest completed historical data piece alone may be acquired. This is because at each time that the predetermined period elapses, the end date and time and the start date and time of the acquisition period move merely by one predetermined period. That is, it is sufficient that within the historical data pieces having been used till then in the calculation, the oldest historical data piece is discarded and then the pivot value and the like are calculated from the historical data pieces following the discarded historical data piece and from the newest completed historical data piece and the not-yet-completed historical data piece containing the newest transaction price.

The present embodiment is described for a case that the pivot value and the like are calculated between 18:00 of the preceding day to 18:00 of the day of interest with adopting a specified range of 24 hours and a predetermined period of 1 hour. Thus, the processing illustrated in FIG. 10 has specifically the following contents. The control unit 10 acquires a value of 1 hour as the predetermined period (S1). The control unit 10 acquires a value of 24 hours as the specified range (S2). The control unit 10 sets forth the acquisition period into a period from 18:00 of the preceding day to 17:00 of the day (S3). Since the data of a period of 17:00 and the following is not yet completed, the control unit 10 acquires 23 historical data pieces from 18:00 of the preceding day to 16:00 of the day (S4). The control unit 10 adopts the lowest price (79.139) in the period of 21:00 of the preceding day as the lowest price of the period, and adopts the highest price (79.689) in the period of 16:00 of the day as the highest price of the period (S5). The control unit 10 acquires 79.830 as the newest transaction price (S6). Since the newest transaction price is a price causing the necessity of updating the highest price, the control unit updates the highest price into 79.830 (S7). No change is necessary in the lowest price (S7). The control unit 10 calculates the pivot value by using the data described here. Since H=79.830, L=79.139, and PR=79.830, according to the above-mentioned Formula A,

$$\begin{matrix}P = ( H + L + PR ) / 3 \\ = ( 79.830 + 79.139 + 79.830 ) / 3 \\ = 79.600\end{matrix}$$

is obtained. Here, rounding-off at the fourth decimal place has been performed. On the basis of the obtained P, the resistances R3, R2, R1 and the supports S1, S2, S3 are calculated according to the above-mentioned Formulas B, C, D, E, F, and G. R3=80.751, R2=80.290, R1=80.060, S1=79.369, S2=78.909, and S3=78.678 are obtained.

Until the time of day of 17:59, the control unit 10 repeats the execution of the processing from S6 to S11 in FIG. 10. At the time of day of 18:00, the control unit 10 concludes YES at S12. Thus, the control unit 10 executes the processing from S3 to S5 and then executes the processing of S6 and subsequent steps. The acquisition period is from 19:00 of the preceding day to 18:00 of the day (S3). The 23 historical data pieces from 19:00 of the preceding day to 17:00 of that day are completed. The control unit 10 acquires these 23 historical data pieces (S4). Here, the data of the period from 19:00 of the preceding day to 16:00 of the day has already been acquired. Thus, not all of the historical data pieces need be acquired. That is, the historical data piece of 18:00 of the preceding day may be discarded and then the completed historical data piece of 17:00 alone may be acquired. From the 23 historical data pieces, the control unit 10 identifies the lowest price and the highest price (S5). The control unit 10 acquires the newest transaction price (S6) and then updates the lowest price and the highest price when necessary (S7). The processing at S8 and subsequent steps is performed similarly to that described above.

As described above, in the real-time pivot technique, the pivot value, the supports (S1, S2, S3), and the resistances (R1, R2, R3) are allowed to be calculated at each time that the newest transaction price is acquired. Thus, in contrast to the conventional pivot technique employing daily data, the real-time pivot technique achieves prediction in accordance with the newest market trend, that is, has real-time nature.

In the example given above, the predetermined period for the data has been set to be 1 hour. However, even when the predetermined period is set to be other value such as 30 minutes and 4 hours, the pivot value is allowed to be calculated by similar processing. Further, the specified range has been set to be 24 hours. However, even when the specified range is set to be other value such as 12 hours and 4 hours, similar processing is allowed.

The above-mentioned description has been given for the calculation processing for the real-time pivot value. However, past values may be calculated by similar processing. For past values, the pivot value is allowed to be calculated by using completed historical data alone. In the example of the present embodiment, the pivot value at 16:00 may be calculated by using the 24 historical data pieces of a period from 17:00 of the preceding day to 16:00 of the day. The newest price is set to be the closing price of the period starting at 16:00. Similarly, the pivot value at 15:00 is calculated by using the 24 historical data pieces of a period from 16:00 of the preceding day to 15:00 of the day. Here, past pivot values do not vary. Thus, values calculated once may be stored into the mass storage device 13 and then read out when necessary. In such a case, it is more preferable that the calculation is performed in advance for all values allowed to be selected as the predetermined period for the data. Further, past pivot values may be stored in the financial product transaction management apparatus 2 or the like and then the index value calculation apparatus 1 may acquire the values when necessary.

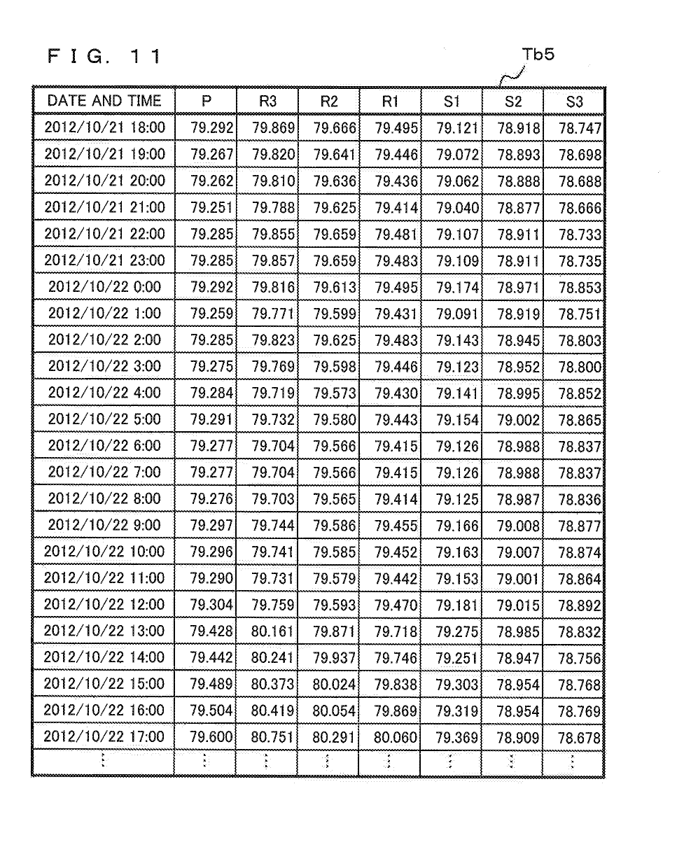

A table for storing past pivot values is illustrated below. FIG. 11 is a diagram illustrating an example of a record layout of a pivot value storage table Tb5 (an index value storage part). The figure illustrates a case that the pivot value is calculated with adopting a predetermined time for the data of 1 hour and a specified range of 24 hours. The pivot value storage table Tb5 includes a date and time field, a P field, an R3 field, an R2 field, an R1 field, an S1 field, an S2 field, and an S3 field. The date and time field stores a time of day in accordance with the predetermined time for the data. In the example illustrated in FIG. 11, it is illustrated that the value in the date and time field corresponds to the 1-hour data of a period of Oct. 21, 2012 18:00. That is, this data is a result obtained by calculating the real-time pivot value from 24 hourly data pieces of the periods from Oct. 20, 2012 19:00 to Oct. 10, 2012 18:00. The P field to the S3 field individually store the pivot value, the resistance line values R3 to R1, and the support line values S1 to S3. In the example illustrated in FIG. 11, hourly data and the specified range of 24 hours have been employed. However, even for other combinations, data is stored similarly. Further, in addition to past values having been completed, the newest values may also be stored into the pivot value storage table Tb5. Further, conventional pivot values (pivot values calculated from daily data) may also be stored into a table similar to the pivot value storage table Tb5.

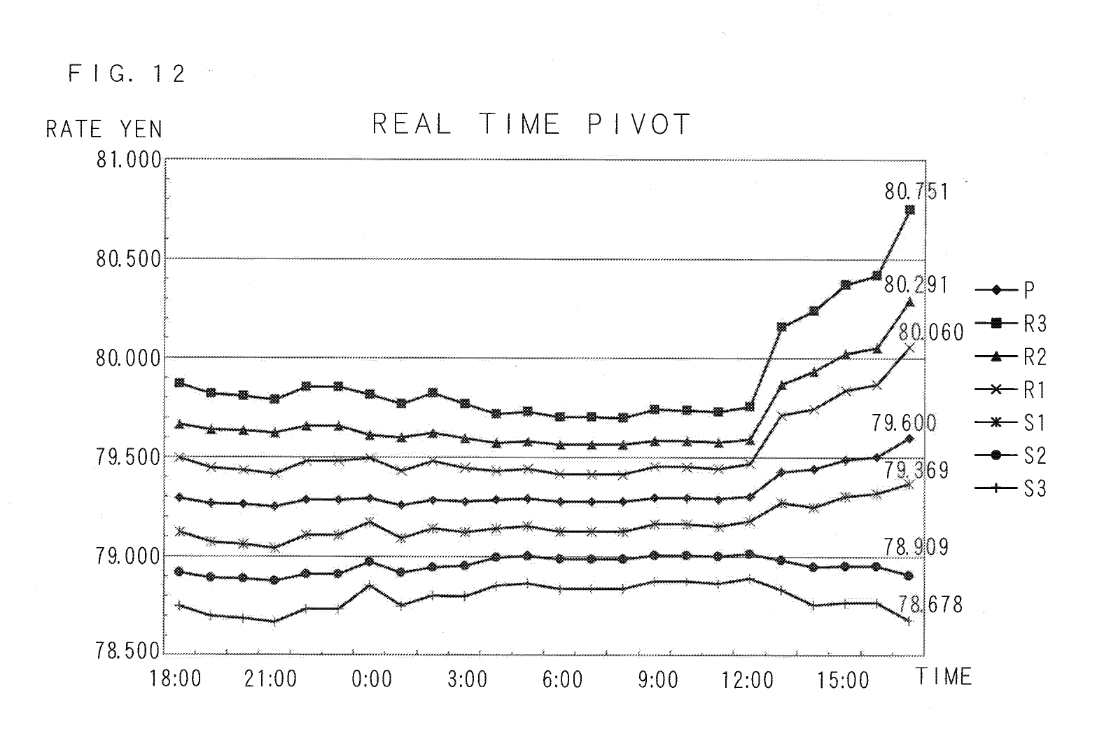

FIG. 12 is a graph illustrating pivot values. The horizontal axis indicates the time of day. The vertical axis indicates the rate. In addition to the newest pivot values described above, past pivot values also are illustrated in the table. The point series indicate R3, R2, R1, P, S1, S2, and S3 from top to bottom (in descending order of the rate).

Next, an ordering function utilizing the pivot values is described below. The ordering method employed in the present embodiment is an IFO (If Done+One Cancels the Other order) order. The IFO order indicates a combination between: an IFD (If Done) order in which a limit order is combined with a profit taking or loss cut order; and an OCO (One Cancels the Other order) order composed of a pair of orders in which when contract has been established for one order, the other order is canceled. That is, this ordering method is a combination of a limit order, a profit taking order, and a loss cut order. Thus, when contract has been established for the limit order, the profit taking order and the loss cut order are activated. Then, when contract has been established for any one of the profit taking order and the loss cut order, the other order is canceled.

A basic strategy employing the pivot technique is “buy at a support line and sell at a resistance line”. In the present embodiment, four ordering patterns including this are allowed to be set forth in advance. The four ordering patterns are referred to as “buy/limit”, “sell/limit”, “buy/counter”, and “sell/counter”, respectively. The “buy/limit” indicates an ordering pattern of buy at S1, profit taking at R1, and loss cut at S3. The “sell/limit” indicates an ordering pattern of sell at R1, profit taking at S1, and loss cut at R3. The “buy/counter” indicates an ordering pattern of buy at R1, profit taking at R2, and loss cut at S1. The “sell/counter” indicates an ordering pattern of sell at S1, profit taking at S2, and loss cut at R1. Since such ordering patterns are prepared, the user is allowed to set forth an IFO order without the necessity of inputting an order price.

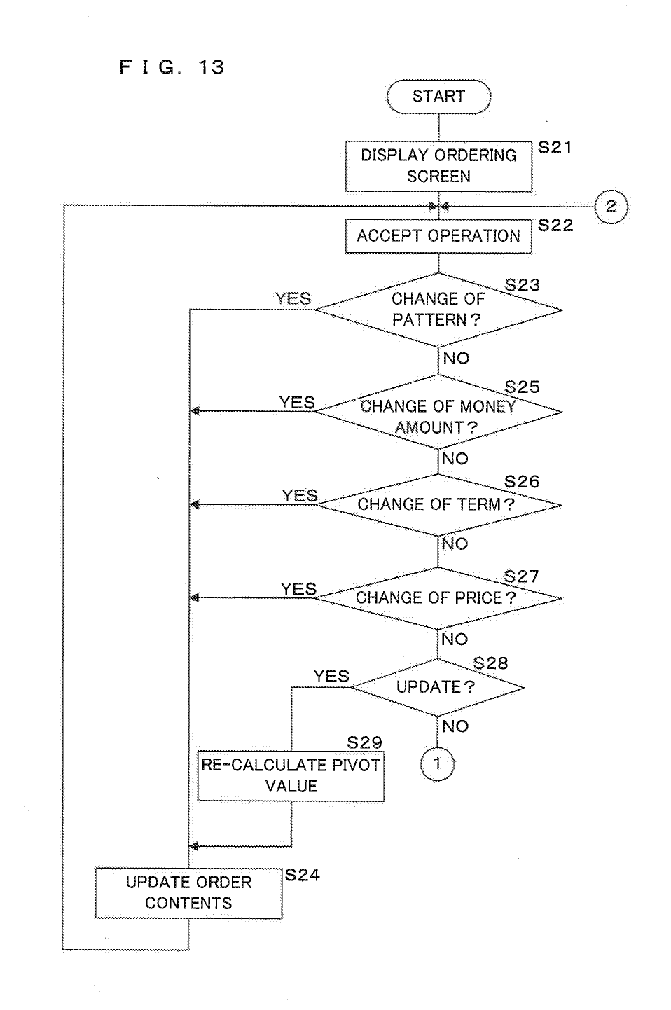

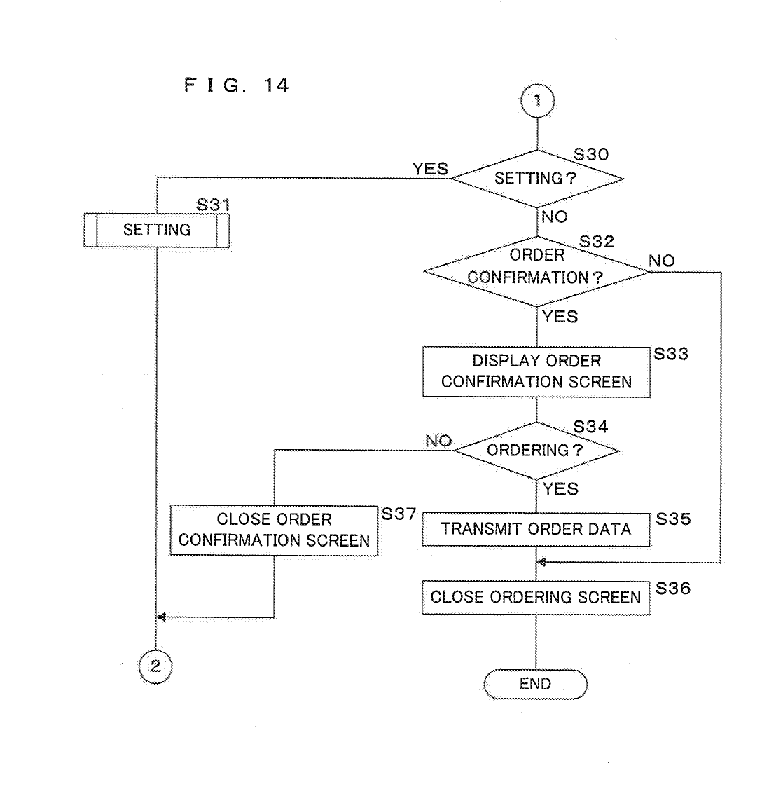

FIGS. 13 and 14 are flow charts illustrating the order processing. In response to an order start operation by the user, the control unit 10 of the index value calculation apparatus 1 displays an ordering screen (S21). The control unit 10 accepts an operation of the user (S22). The control unit 10 judges whether the operation is an operation of ordering pattern change (S23). In case of an ordering pattern changing operation (YES at S23), the control unit 10 updates the order contents displayed on the ordering screen (S24) and then returns the processing to S22. In case of not being an ordering pattern changing operation (NO at S23), the control unit 10 judges whether the operation is a changing operation for the transaction money amount (S25). In case of a changing operation for the transaction money amount (YES at S25), the control unit 10 updates the order contents (S24) and then returns the processing to S22. In case of not being a changing operation for the transaction money amount (NO at S25), the control unit 10 judges whether the operation is a changing operation for the term (S26). In case of a changing operation for the term (YES at S26), the control unit 10 updates the order contents (S24) and then returns the processing to S22. In case of not being a changing operation for the term (NO at S26), the control unit 10 judges whether the operation is a changing operation for the order price (S27). In case of a changing operation for the order price (YES at S27), the control unit 10 updates the order contents (S24) and then returns the processing to S22. In case of not being a changing operation for the order price (NO at S27), the control unit 10 judges whether the operation is an updating operation (S28). In case of an updating operation (YES at S28), the control unit 10 re-calculates the pivot value on the basis of the newest transaction price (S29). The control unit 10 updates the order contents on the basis of the result of re-calculation (S24) and then returns the processing to S22. In case of not being an updating operation (NO at S28), the control unit 10 judges whether the operation is a setting operation (S30). In case of a setting operation (YES at S30), the control unit 10 performs setting (S31) and then returns the processing to S22.

Here, in addition to the above-mentioned occasion that an updating operation has been performed, the re-calculation of the pivot value described above may be performed at each time that the transaction price is acquired. In this case, re-calculation of the pivot value (S29) is unnecessary and it is sufficient that the order contents alone are updated on the basis of the newest calculation result (S24).

In case of not being a setting operation (NO at S30), the control unit 10 judges whether the operation is an order confirmation operation (S32). In case of an order confirmation operation (YES at S32), the control unit 10 displays an order confirmation screen (S33). Then, the control unit 10 judges whether an ordering operation has been performed in the order confirmation screen (S34). When an ordering operation has been performed (YES at S34), the control unit 10 transmits the order data to the financial product transaction management apparatus 2 (S35). Then, the control unit 10 closes the ordering screen (S36) and then terminates the processing. When the operation in the order confirmation screen is not an ordering operation (NO at S34), the control unit 10 closes the order confirmation screen (S37) and then returns the processing to S22. When the operation in the ordering screen is not any one of the above-mentioned operations (NO at S32), the operation is a cancellation operation or a window closing operation. Thus, the control unit 10 closes the ordering screen (S36) and then terminates the processing.

Here, in the flow charts illustrated in FIGS. 13 and 14, the procedure of determining the operation performed by the user is merely exemplary. That is, employable procedures are not limited to that described here. It is sufficient that the control unit 10 acquires an operation performed by the user and then processing in accordance with this is achieved.

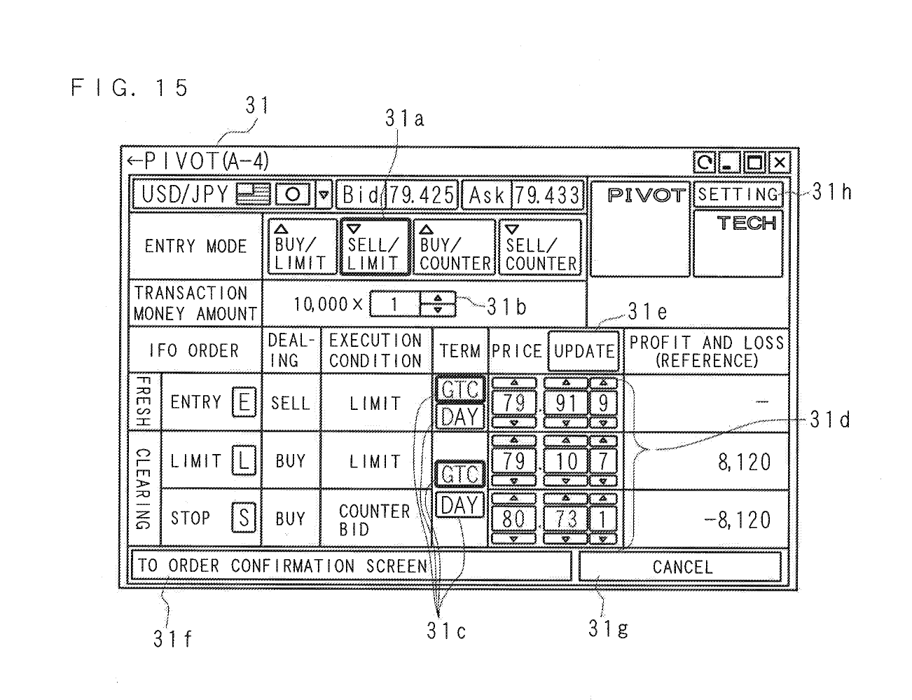

FIG. 15 is a diagram illustrating an example of an ordering screen 31. Four ordering pattern selection buttons 31a respectively correspond to the ordering patterns. In the example illustrated in FIG. 15, “sell/limit” is selected. A transaction money amount changing area 31b is used for changing the number of units of the transaction money amount. When a button displayed on the right-hand side of the numeric characters is clicked by using the mouse or the like, changing of the number of units is achieved. When the triangular button is operated, the number of units increases. When the inverted triangular button is operated, the number of units decreases. The part in which the numeric characters are displayed may be selected and then a value may directly be inputted through the ten-key pad or the like. A term changing area 31c is used for changing the term of validity of the order. A term of validity is allowed to be set forth for each of the fresh order and the clearing order. When a GTC button or a DAY button is clicked by using the mouse or the like, the change is achieved. In the example illustrated in FIG. 15, GTC is selected for both of the fresh order and the clearing order. A price changing area 31d is used for changing individually the entry (order) price, the limit (profit taking) price, and the stop (loss cut) price. For each price, buttons are provided for each of the integer part, the point part below the decimal point, and the below-the-point part. The point indicates a unit generally employed in exchange transactions. The method of their operation is similar to that of the transaction money amount changing area 31b. A price update button 31e is used for updating the order price into a value based on the newest pivot value. When an order confirmation button 31f is clicked by using the mouse or the like, the order confirmation screen is displayed. When a cancel button 31g is clicked by using the mouse or the like, the ordering screen is closed and the order contents are discarded. A setting button 31h is used for displaying a setup changing screen. The currency pair adopted as the object of ordering is illustrated in an upper left part of the screen. The present rate is displayed on the right thereof. “Bid” indicates the price used when the user sells the transaction currency. “Ask” indicates the price used when the user buys the transaction currency. Further, the profit and loss field display: a profit amount calculated from the order (entry) price and the profit taking (limit) price; and a loss amount calculated from the order price and the loss cut (stop) price.

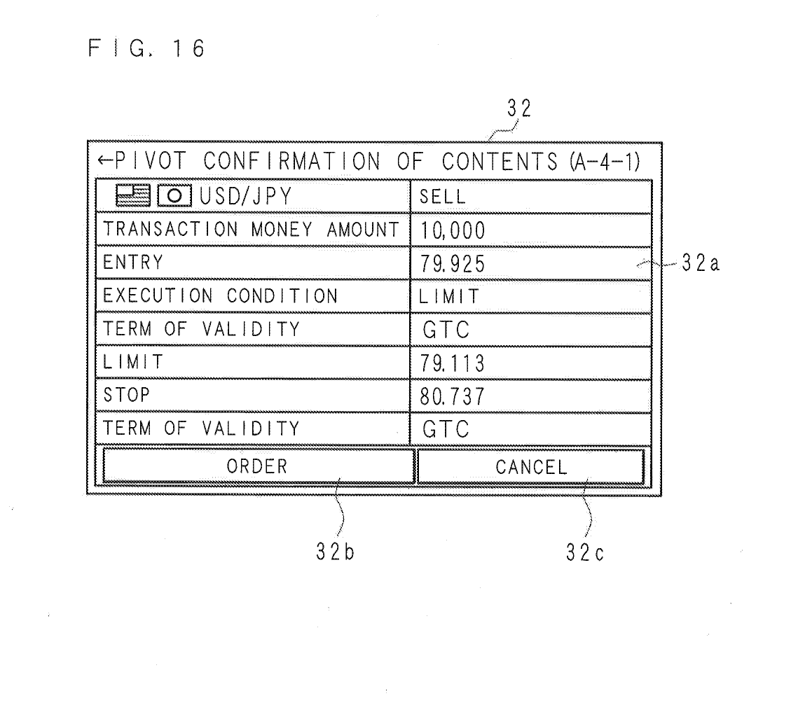

FIG. 16 is a diagram illustrating an example of an order confirmation screen 32. A contents displaying area 32a of the order confirmation screen 32 displays the currency pair to be ordered, the dealing type, the transaction money amount, the entry price, the execution condition, the term of validity, the limit price, the stop price, and the term of validity. When an order button 32b is clicked by using the mouse or the like, the order data is transmitted to the financial product transaction management apparatus 2 so that the ordering procedure is completed. When a cancel button 32c is clicked by using the mouse or the like, the order is not placed and then the order confirmation screen is closed. Then, the ordering screen 31 is displayed again.

As described above, the index value calculation apparatus 1 according to Embodiment 1 calculates the real-time pivot value, that is, the pivot value using the newest transaction price, and then provides the value to the user. Thus, the user is allowed to place an order in accordance with the newest market trend.

Further, ordering patterns are prepared in which the support lines (S1, S2, S3) and the resistance lines (R3, R2, R1) obtained by pivot value calculation are related to the order price, the profit taking price, and the loss cut price. Thus, the user is allowed to place an IFO order without the necessity of inputting an order price.

Here, in the present embodiment, three support lines and three resistance lines have been employed together with the pivot value P. However, employable configurations are not limited to this. That is, the following auxiliary lines may be employed together.

M5=(R2+R3)/2 (Formula H)

M4=(R1+R2)/2 (Formula I)

M3=(PR+R1)/2 (Formula J)

M2=(PR+S1)/2 (Formula K)

M1=(S1+S2)/2 (Formula L)

M0=(S2+S3)/2 (Formula M)

When such auxiliary lines are added, values displayed on a central rate changing area need be changed. However, this change may be performed suitably in correspondence to the form of business. For example, all central rates may be displayed. Alternatively, the number of displayed values may be unchanged and values selected in advance alone may be displayed.

### Embodiment 2

In the above-mentioned Embodiment 1, the correspondence relations between the pivot value, the support lines, and the resistance lines having been calculated and the order price, the profit taking price, and the loss cut price have been set forth in advance. In Embodiment 2, the user is allowed to change the correspondence relations dynamically at the time of placing an order. The configuration of an index value calculation apparatus 1 according to Embodiment 2 is similar to that of Embodiment 1, and hence description is omitted.

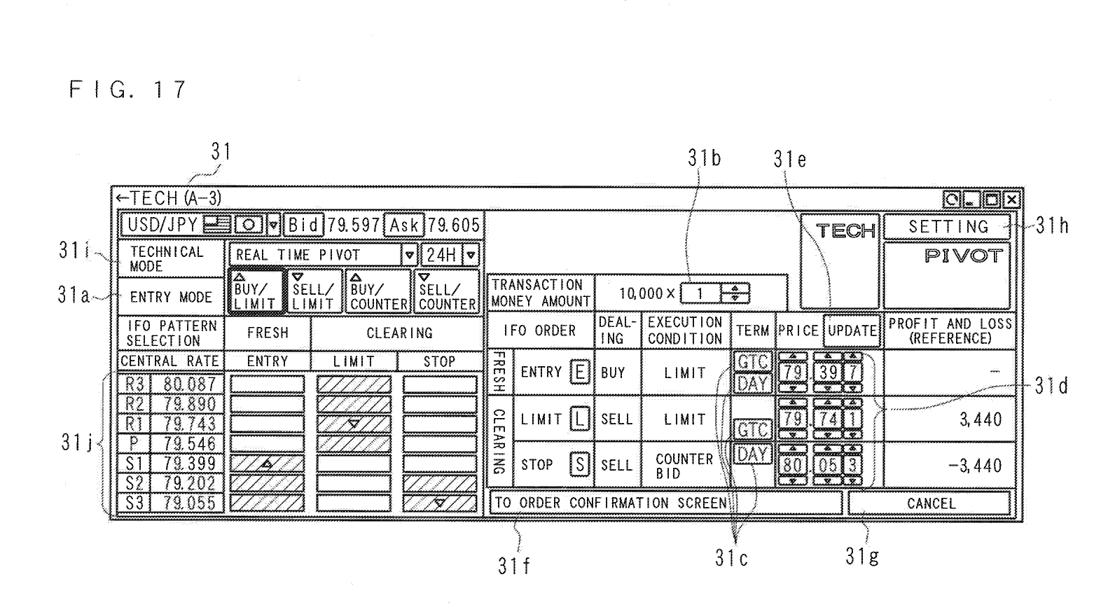

FIG. 17 is a diagram illustrating an example of an ordering screen 31 according to Embodiment 2. Like elements to the ordering screen 31 in Embodiment 1 are designated by like numerals, and hence description is omitted. In the ordering screen 31 in Embodiment 2, a technical mode specification area 31i and a central rate changing area 31j are added. Technical modes include real-time pivot, ordinary pivot, and manual step. When the real-time pivot is selected as the technical mode, a pull-down menu used for setting forth the specified range appears on the right-hand side of the mode selection pull-down menu so that the specified range is allowed to be set forth. For example, the specified range is 1 hour, 4 hours, 12 hours, or 24 hours. In the present specification, description is given mainly for the real-time pivot mode. In the example illustrated in FIG. 17, “buy/limit” is selected as the ordering pattern (the entry mode).

The central rate changing area 31j is used for changing the correspondence relations between: the resistance lines, the pivot value, and the support lines; and the order price (the entry price), the profit taking price (the limit price), and the loss cut price (the stop price). The instruction column in the central rate changing area 31j displays the calculated values of the pivot value (P), the resistance lines (R3, R2, R1) and the support lines (S1, S2, S3). These values are re-calculated and updated at each time that the transaction price is updated.

The fresh/entry column is used for changing the correspondence relation between the order price and the pivot value and the like. The clearing/limit column is used for changing the correspondence relation between the profit taking price and the pivot value and the like. The clearing/stop column is used for changing the correspondence relation between the loss cut price and the pivot value and the like. In each column, a button is displayed in a cell corresponding to the pivot value and the like. Each button indicated by a triangle mark is a button indicating the correspondence relation. In the example illustrated in FIG. 17, the attention price is specified at S1. The profit taking price is specified at R1 and the stop price is specified at S3. When the button displayed in each column is clicked by using the mouse or the like, the correspondence relation between the price and the pivot value and the like is allowed to be changed. When the correspondence relation is changed, the value of the corresponding price in the price changing area 31d is updated.

The order processing in the present embodiment is similar to that of Embodiment 1. Thus, differences alone are described below. In the present embodiment, the price is allowed to be changed also by using the central rate changing area 31j. Thus, when whether the operation is a price changing operation is to be judged, the control unit 10 judges whether the price has been changed by using the central rate changing area 31j (S27). In association with this, the control unit 10 updates the displayed contents in the central rate changing area 31j and the price changing area 31d (S24). Further, when the specified range for the real-time pivot value is changed, the control unit 10 performs processing similar to the updating operation. That is, the control unit 10 changes the specified range, then re-calculates the pivot value (S29), and then updates the displayed contents in the central rate changing area 31j and the price changing area 31d (S24).

Next, brief description is given for the technical modes other than the real-time pivot mode. In the ordinary pivot mode, the conventional pivot value and the like obtained from daily data are displayed in the central rate changing area 31j. The values of the order price, the profit taking price, and the loss cut price are allowed to be determined on the basis of the correspondence relations with the pivot value and the like having been set forth in advance, and then an order is allowed to be placed. The correspondence relations may be changed by using the central rate changing area 31j or alternatively the values in the price changing area 31d may be changed. After that, an order may be placed.

In the manual step mode, the prices are allowed to be determined without using the pivot value and the like and then an order is allowed to be placed. The central rate changing area 31j displays prices obtained by increasing or decreasing the present price by the unit set forth in advance, on and under the present price located at center. For example, displayed central rates are the present price+50, the present price+25, the present price+10, the present price, the present price−10, the present price−25, and the present price−50. By virtue of this, without the necessity of changing the individual prices in the price changing area 31d, an IFO order is allowed to be placed by using the value above or below the present price.

In addition to the effects obtained by the index value calculation apparatus 1 according to Embodiment 1, the index value calculation apparatus 1 according to Embodiment 2 has the following effects.

In the index value calculation apparatus 1 according to Embodiment 2, the specified range which is the range of data used in the pivot value calculation is allowed to be selected. Thus, even in a case that the trend of the market has varied rapidly, calculation of the pivot value by using the historical data posterior to the rapid change alone is achieved when the specified range is selected appropriately. Thus, in case of occurrence of a rapid change in the trend, an IFO order is allowed to be placed in a state that the order price, the profit taking price, and the loss cut price are set forth on the basis of the suitable pivot value.

Further, the relations between the order price, the profit taking price, the loss cut price, and the pivot value and the like are allowed to be changed at the time of placing an order. Thus, the user is allowed to change the individual prices with examining the market trend and the risk.

### Embodiment 3

In the index value calculation apparatus 1 according to Embodiment 1, the relations between the order price, the profit taking price, the loss cut price, and the pivot value and the like are set forth in advance and not allowed to be changed. In the index value calculation apparatus 1 according to Embodiment 2, the relations between the order price, the profit taking price, the loss cut price, and the pivot value and the like are set forth in advance but allowed to be changed at the time of placing an order. In an index value calculation apparatus 1 according to Embodiment 3, the relations between the order price, the profit taking price, the loss cut price, and the pivot value and the like having been set forth in advance are allowed to be changed by the user. The configuration of the index value calculation apparatus 1 according to Embodiment 3 is similar to that of Embodiment 1, and hence description is omitted.

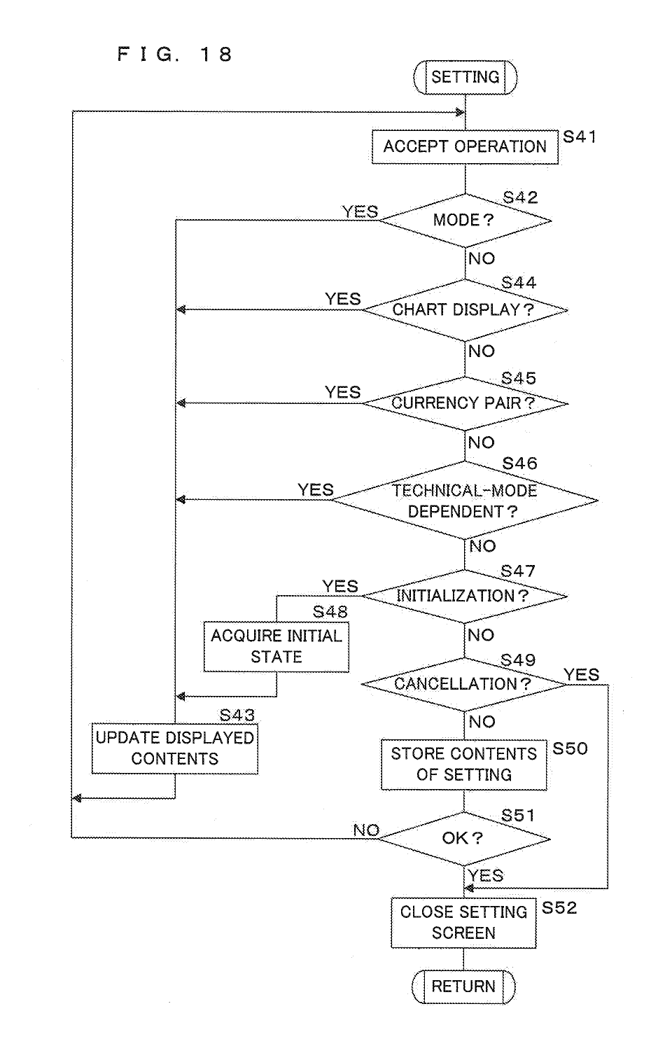

FIG. 18 is a flow chart illustrating initial setting processing for the ordering screen 31. The initial setting indicates the setting of the initial state at the time that the ordering screen 31 is displayed at first. The control unit 10 of the index value calculation apparatus 1 accepts an operation by the user (S41). The control unit 10 judges whether the operation is setting into the initial technical mode (S42). In case of initial technical mode setting (YES at S42), the control unit 10 updates the displayed contents (S43) and then returns the processing to S41. In case of not being of initial technical mode setting, the control unit 10 judges whether the operation is setting of chart display (S44). In case of setting of chart display (YES at S44), the control unit 10 updates the displayed contents (S43) and then returns the processing to S41. In case of not being setting of chart display (NO at S44), the control unit 10 judges whether the operation is setting of the currency pair (S45), In case of setting of the currency pair (YES at S45), the control unit 10 updates the displayed contents (S43) and then returns the processing to S41. In case of not being setting of the currency pair (NO at S45), the control unit 10 judges whether the operation is technical-mode dependent setting (S46). In case of technical-mode dependent setting (YES at S46), the control unit 10 updates the displayed contents (S43) and then returns the processing to S41. In case of not being technical-mode dependent setting (NO at S46), the control unit 10 judges whether the operation is initialization (S47). In case of initialization (YES at S47), the control unit 10 acquires the initial state (S48). The control unit 10 updates the displayed contents in accordance with the acquired initial state (S43) and then returns the processing to S41. In case of not being initialization (NO at S47), the control unit 10 judges whether the operation is cancellation (S49). In case of cancellation (YES at S49), the control unit 10 closes the setting screen without reflecting the contents of setting change (S52) and then terminates the processing. In case of not being cancellation (NO at S49), the control unit 10 stores the contents of the setting (S50). Then, the control unit 10 judges whether the operation is an OK operation (S51). In case of an OK operation (YES at S51), the control unit 10 closes the setting screen (S52) and then terminates the processing. In case of not being an OK operation (NO at S51), the operation is an apply operation. Thus, the control unit 10 returns the processing to S41. Here, the contents of the setting is stored into the mass storage device 13 of the index value calculation apparatus 1. Alternatively, the contents of the setting may be stored into other apparatus such as the financial product transaction management apparatus 2, and then may be read out. The same situation holds for the initial state. Since the initial state is not changed, the data may be embedded in the control program 18.

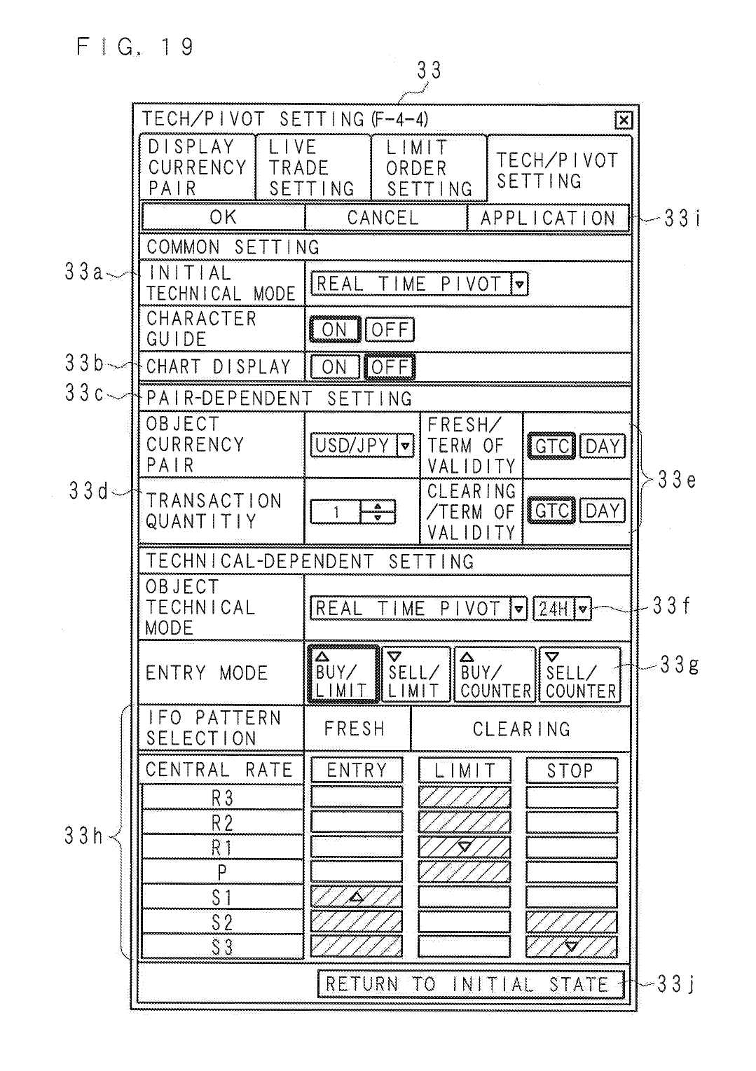

FIG. 19 is a diagram illustrating an example of a setting screen 33. The setting screen 33 is used for initial setting of an ordering screen 32. An initial technical mode setting area 33a is used for initial setting of the technical mode. A technical mode is selected from the pull-down menu. Available modes include real-time pivot, ordinary pivot, and manual step. A chart display setting area 33b is used for initial setting of display or non-display of the chart. An object currency pair setting area 33c is used for initial setting of the object currency pair. A transaction quantity setting area 33d is used for initial setting of the transaction quantity. Here, the transaction currency unit is premised to be set forth in advance. In this example, the transaction currency unit is set to be 10,000 for all transaction currencies. For example, in a case that the currency pair is dollar-yen and that the transaction quantity is 1, a selling order or a buying order of 10,000 dollars is placed unless the order contents are not changed in the ordering screen 32. A term of validity setting area 33e is used for initial setting of the term of validity for a fresh order and a clearing order (a profit taking order or a loss cut order). “Fresh/term of validity” indicates the term of validity for the fresh order. “Clearing/term of validity” indicates the term of validity for the clearing order. Available term of validity is GTC or DAY. Here, initial setting of the transaction quantity, the fresh/term of validity, and the clearing/term of validity is allowed for each currency pair.

In the technical-dependent setting, different setting is used for each technical mode. FIG. 19 illustrates the case of real-time pivot mode. A specified range area 33f is used for initial setting of the range of the data (the specified range) specified when the real-time pivot value is to be calculated. The selection is achieved by using the pull-down menu. For example, one is selected from among 24H (24 hours), 12H (12 hours), 4H (4 hours), and 1H (1 hour). A correspondence relation setting area 33h is used for initial setting of the correspondence relations between the central rates and the order price (the entry price), the profit taking price (the limit price), and the loss cut price (the stop price). The correspondence relations are allowed to be set forth for each ordering pattern (each entry mode). FIG. 19 illustrates the case of “buy/limit”. The order price is set at S1, the profit taking price is set at R1, and the loss cut price is set at S3. An initial state button 33j is used for canceling the contents of the setting and returning to the initial state set forth in advance.

Next, description is given for technical-dependent setting in a technical mode other than the real-time pivot. When the technical mode is set to be the ordinary pivot, in contrast to the case of real-time pivot, the specified range setting area 33f is not displayed. The correspondence relation setting area 33h is similar. In the case of manual step, the specified range setting area 33f is not displayed. In the correspondence relation setting area 33h, the central rate field is different. In the case of manual step, the value displayed in the center is not the pivot value P and is the newest transaction price PR. In place of R1, R2, and R3, +1, +2, and +3 are displayed. In correspondence to these, a level setting area is displayed. The level indicates a value to be added to the newest transaction price. Similarly, in place of S1, S2, and S3, −1, −2, and −3 are displayed. In correspondence to these, a level setting area is displayed. The level indicates a value to be subtracted from the newest transaction price. Further, similarly to the case of real-time pivot value, initial setting of the correspondence relations between each step value (+1, +2, +3, −1, −2, −3) and the order price (the entry price), the profit taking price (the limit price), and the loss cut price (stop) is allowed for each ordering pattern.

In addition to the effects obtained by the index value calculation apparatus 1 according to Embodiments 1 and 2, the index value calculation apparatus 1 according to Embodiment 3 has the following effects.

In the index value calculation apparatus 1 according to Embodiment 3, initial setting of the ordering screen is allowed to be performed by the user. Thus, each user may perform initial setting in accordance with the contents of orders placed frequently by the user. This allows the user to place IFO orders by a procedure of small amount.

### Embodiment 4

An index value calculation apparatus 1 according to Embodiment 4 provides a function that the order price, the profit taking price, and the loss cut price are allowed to be determined with reference to a chart. The configuration of the index value calculation apparatus 1 according to Embodiment 4 is similar to that of Embodiment 1, and hence description is omitted.

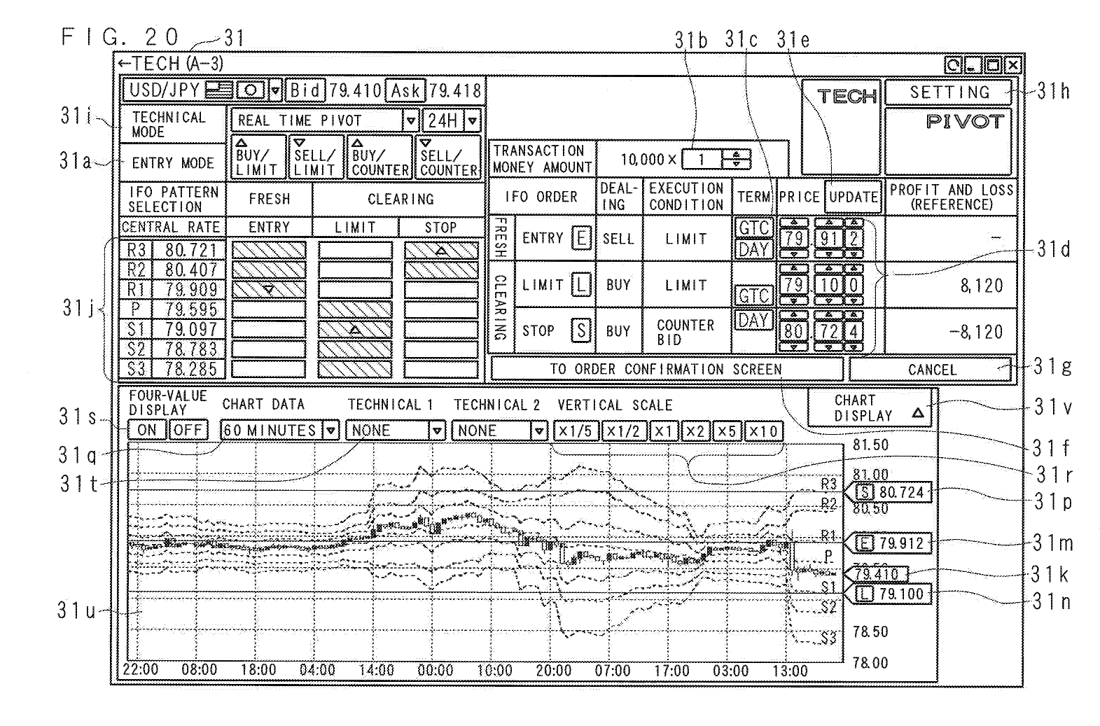

FIG. 20 is a diagram illustrating an example of an ordering screen 31 according to Embodiment 4. Like elements to the ordering screen 31 in Embodiment 2 are designated by like numerals, and hence description is omitted. In the ordering screen 31 in Embodiment 4, the order price is allowed to be set forth by using a chart. As illustrated in FIG. 20, in the chart, the horizontal axis indicates time and the vertical axis indicates the price. In the example illustrated in FIG. 20, the chart displays a candlestick chart (chart data), the pivot value P, the resistance lines R1, R2, R3, and the support lines S1, S2, S3. The chart further displays the newest transaction price 31k, the order price 31m, the profit taking price 31n, and the loss cut price 31p. This chart is generated by using the data stored in the historical data table Tb1, the pivot value storage table Tb5, and the like.

Further, a chart data changing menu 31q is used for changing the predetermined period. For example, the value is selected from among 60 minutes, 30 minutes, 10 minutes, and 1 minute. A vertical scale setting button 31r is used for changing the scale of the vertical axis. A four-value display setting button 31s is used for setting whether the four values are to be displayed within a speech balloon when a time point on the chart is specified by using the mouse pointer or the like. A technical-1 setting menu 31t and a technical-2 setting menu 31u are each used for setting forth a technical index to be displayed simultaneously on the chart. The index selected in the technical-1 setting menu 31t is a technical index to be displayed in a manner of being superposed on the chart illustrated in FIG. 20. Such indices include the moving average line, the Bollinger band, and the glance-at-equilibrium chart. The technical index selected in the technical-2 setting menu 31u is a technical index to be displayed in a manner of being aligned with the chart illustrated in FIG. 20 along the same time axis. Such technical indices include the Stochasties, the RSI (Relative Strength Index), the MACD (Moving Average Convergence/Divergence Trading Method), and the deviation percentage. A chart display button 31v is used for switching the display or non-display of the chart.

When the order price 31m, the profit taking price 31n, and the loss cut price 31p displayed on the chart are moved by using the mouse and the like, the individual prices are allowed to be changed. In accordance with this, the values displayed on the price changing area 31d are also updated. Further, when the central rate changing area 31j and the price changing area 31d are operated so that the price values are changed, the order price 31m, the profit taking price 31n, and the loss cut price 31p displayed on the chart are also updated.

In addition to the effects obtained by the index value calculation apparatus 1 according to Embodiments 1 to 3, the index value calculation apparatus 1 according to Embodiment 4 has the following effects.

When the order price 31m, the profit taking price 31n, and the loss cut price 31p displayed on the chart are moved by using the mouse and the like, the individual prices are allowed to be changed. This allows the user to perform price setting by intuitive operation. Further, the use of a chart permits easy determination of the prices with consideration of time-dependent changes in the candlestick chart, the pivot value, the support lines, and the resistance lines.

In the above-mentioned Embodiments 1 to 4, the index value calculation apparatus 1 has been implemented by a user terminal. However, the configuration is not limited to this, and may be implemented by an ASP service (Application Service Provider Service). That is, the function of the index value calculation apparatus 1 may be provided in the financial product transaction management apparatus 2. The terminal (the user terminal) used by the user may be composed of a general-purpose computer. Then, the financial product transaction management apparatus 2 may perform pivot value calculation and then transmit the result to the user terminal. Then, the user terminal may display the calculation result.

### Embodiment 5

In the above-mentioned Embodiments 1 to 4, the term of validity for a fresh order, a profit taking order, and a loss cut order has been GTC or DAY. In the present embodiment, the term of validity is set forth by using the specified range for the real-time pivot. In the calculation in the real-time pivot technique, historical data contained in the specified range is used. This is a notion that by definition of the pivot formula (Formula A), the pivot value is calculated in the specified range and then adopted as the width of market price fluctuation in the future of a specified range from the present. For example, the data of past 24 hours are used so that the width of market price fluctuation in the future of 24 hours is obtained. Thus, it is expected that the pivot value of the specified range of 24 hours is significant within 24 hours from the present, but loses significance and accuracy after 24 hours. Thus, an order or a position whose contract or clearing is not established within the specified range (e.g., within 24 hours) from the time of placement of the order is desired to be dealt with in any way from the aspect of the rate of return of investment ROI (Return Of Investment). In the present embodiment, the term of validity for the order is set forth by using the specified range for the real-time pivot. Then, an order whose term of validity has elapsed is updated, canceled, or the like. Here, the configuration of the index value calculation apparatus 1 according to Embodiment 5 is similar to that of the index value calculation apparatus 1 according to the above-mentioned Embodiment 1. Thus, description thereof is omitted.

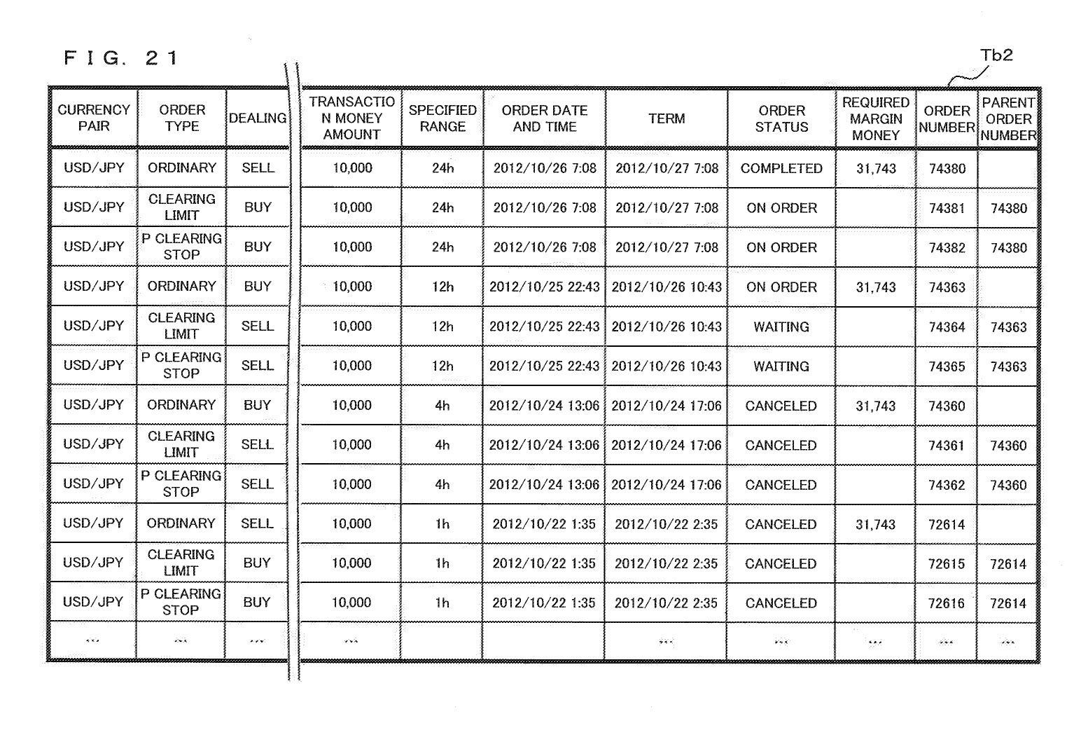

FIG. 21 is a diagram illustrating an example of a record layout of an order data table Tb2 according to Embodiment 5. In the order data table Tb2, a specified range field and an order date and time field are added to that of Embodiment 1 described above. The flowing description is given mainly for differences from Embodiment 1, and description of points of similarity is omitted. The specified range field stores the specified range of the data used when the real-time pivot value was calculated. When the order has been placed not using the real-time pivot, the field stores a value of blank, 0, or the like. The order date and time field stores the order date and time. The term field stores the term of validity of the order. When the order has been placed by using the real-time pivot, the term of validity is calculated from the specified range and the order date and time, and then stored. For example, The order having an order number of 74380 has been placed at 7:08 on Oct. 26, 2012 by using the real-time pivot of specified range of 24 hours. Thus, the adopted term is 7:08 on Oct. 27, 2012. When the real-time pivot is not used, GTC or DAY is stored similarly to Embodiment 1.

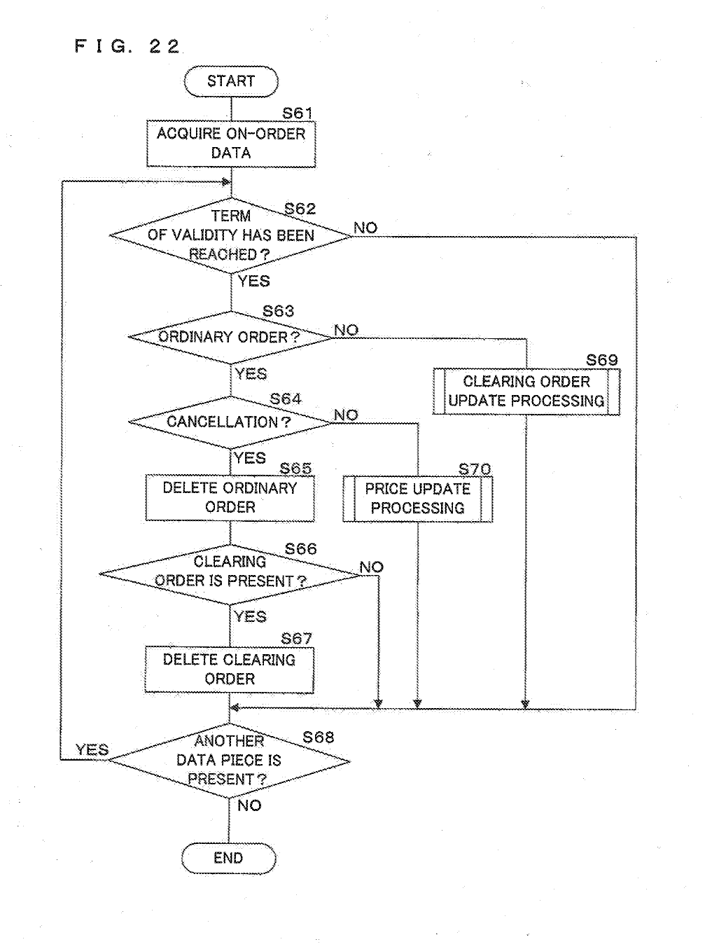

FIG. 22 is a flow chart illustrating order update or cancellation processing based on the term of validity. The control unit 10 of the index value calculation apparatus 1 acquires a data piece whose order status in the order data table Tb2 is on-order (S61). The control unit 10 compares the term of the acquired order data piece with the present date and time acquired from a clock part (not illustrated), and then judges whether the term of validity of the order data piece has been reached (S62). In a case that the term of validity has been reached (YES at S62), the control unit 10 judges whether the order is an ordinary order (S63). In case of an ordinary order (YES at S63), the control unit 10 judges whether the order is to be canceled (S64). The setting whether the order is to be canceled or the price is to be updated when the order term has been reached is premised to be performed in advance by the user, the manager, or the like. This setting may be in common with all orders. Alternatively, the setting may be performed for each order at each time of input of the order. When it is concluded that the order is to be canceled (YES at S64), the control unit 10 deletes the ordinary order (S65). The control unit 10 judges whether any clearing order (a profit taking order or a loss cut order) is related to the eliminated ordinary order (S66). In case of presence of a clearing order (YES at S66), the control unit 10 deletes the clearing order (S67). The control unit 10 judges whether any other data piece is on order (S68). In case of the presence of another data piece on order (YES at S68), the control unit 10 returns the processing to S62. In case of the absence of another data piece on order (NO at S68), the control unit 10 terminates the processing. At S62, when the term of validity has not yet been reached (NO at S62), the control unit 10 transfers the processing to S68. At S66, when no clearing order is present (NO at S66), the control unit 10 transfers the processing to S68. At S63, when the order is not an ordinary order, that is, when the order is a clearing order (NO at S63), the control unit 10 performs clearing order update processing (S69) and then transfers the processing to S68. At S64, when the order is concluded not to be canceled (NO at S64), the control unit 10 performs price update processing (S70) and then transfers the processing to S68. Here, the deletion of the order may be performed by logical deletion of the data or by physical deletion.

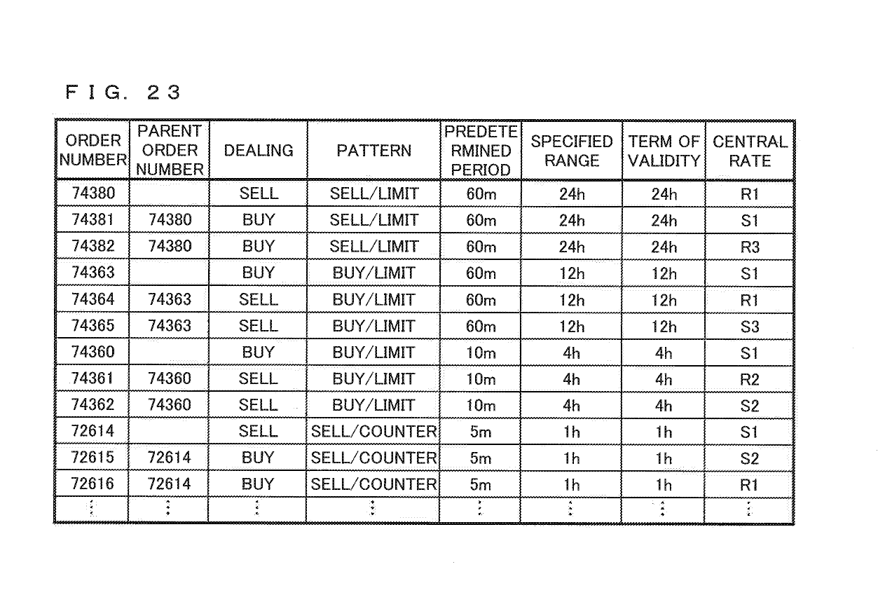

FIG. 23 is a diagram illustrating an example of record layout of an ordering pattern table Tb6 (an ordering pattern storage part). The ordering pattern table Tb6 stores an ordering pattern used when an order was placed by using the real-time pivot. The ordering pattern table Tb6 includes an order number field, a parent order number field, a dealing field, a pattern field, a predetermined period field, a specified range field, a term of validity field, and a central rate field. The order number field stores an order number corresponding to the order. The parent order number field, in case of a clearing order, stores the order number of a fresh order serving as the parent order. The dealing field stores distinction whether the order is a selling order or a buying order. For example, “sell” is stored in case of a selling order and “buy” is stored in case of a buying order. The pattern field stores the selection of any one of the four ordering patterns “buy/limit”, “sell/limit”, “buy/counter”, and “sell/counter” adopted at the time of placing the order. Even for a clearing order, the pattern field is premised to store the same value as a fresh order serving as the parent order. Thus, for example, even when the dealing field stores “buy”, the pattern field stores “sell/limit” or “sell/counter”.

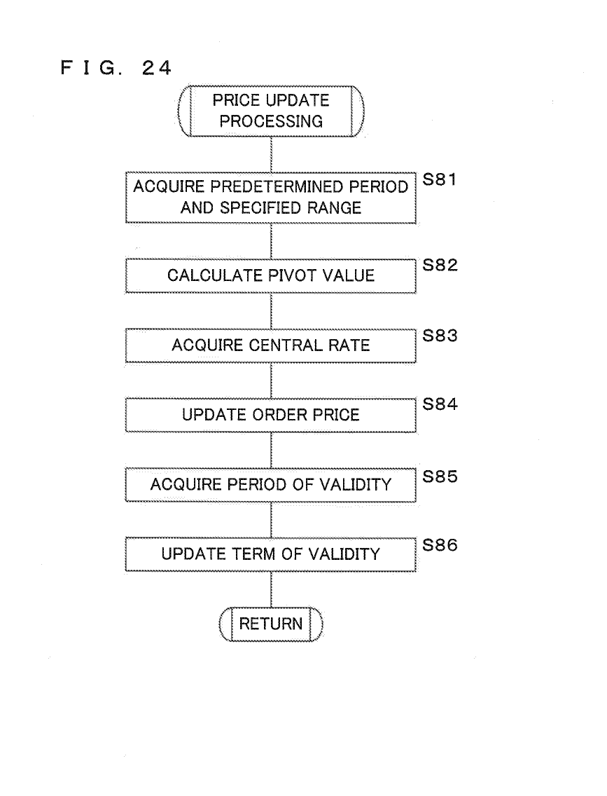

FIG. 24 is a flow chart illustrating price update processing. The control unit 10 of the index value calculation apparatus 1 reads out from the ordering pattern table Tb6 a data piece corresponding to the order number of the order data serving as the processing object, and thereby acquires the predetermined period and the specified range (S81). On the basis of the predetermined period and the specified range having been acquired, the control unit 10 calculates the pivot value (S82). Similarly to S81, the control unit 10 acquires the central rate from the ordering pattern table Tb6 (S83). The central rate expresses the correspondence relations between the individual order prices of the ordinary order, the profit taking order, and the loss cut order and the calculated indices (R3, R2, R1, P, S1, S2, S3). On the basis of the correspondence relations and the calculated index values, the control unit 10 updates the order prices of the individual orders (the ordinary order, the profit taking order, and the loss cut order) serving as processing objects stored in the order data table Tb2 (S84). Similarly to S81, the control unit 10 acquires the period of validity (S85). On the basis of the acquired period of validity, the control unit 10 updates the term of validity of each order serving as the processing object (S86) and then terminates the processing.

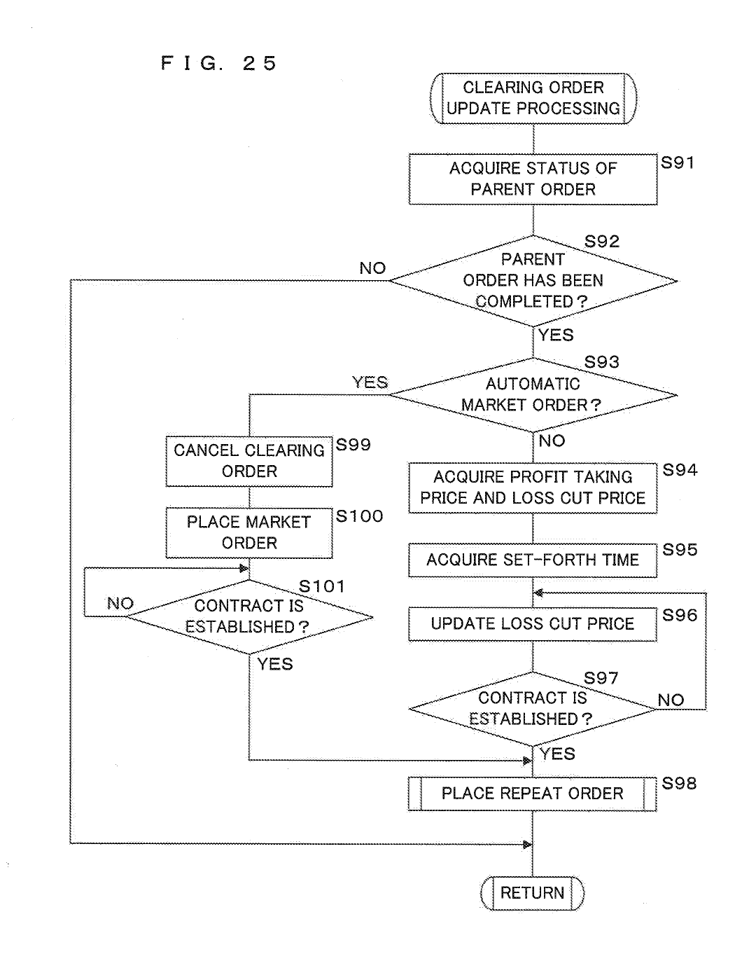

FIG. 25 is a flow chart illustrating clearing order update processing. The clearing order update processing is performed for establishing contract of a clearing order whose order term has been reached. This processing for establishing contract is divided into two parts. One part of the processing is to cancel the clearing order and then place a market order so as to establish contract. The other part is to update periodically the loss cut price in such a manner that the loss cut price should reach or exceed the profit taking price at a fixed later time so as to establish contract. Here, a situation that contract is not established for both of the profit taking order and the loss cut order indicates that the transaction price is fluctuating in an inner part of the range from the profit taking price to the loss cut price. Thus, when the loss cut price is progressively brought close to the profit taking price, the loss cut price reaches or exceeds the order price at last so that contract is established. Further, since the loss cut price is brought close to the profit taking price, contract is established at a transaction price causing a smaller loss than the original loss cut price. In the following description, the fixed time length elapsing until the loss cut price reaches or exceeds the profit taking price is referred to as a set-forth time.

The control unit 10 acquires the status of the parent order of the clearing order serving as the processing object (S91). The control unit 10 judges whether the parent order has been completed (S92). When the parent order is not yet completed (contract is not yet established) (NO at S92), the price update processing described above has been performed together with the parent order and hence the control unit 10 terminates the processing. When the parent order has been completed (YES at S92), the control unit 10 judges whether an automatic market order is to be placed (S93). The setting whether an automatic market order is to be placed is premised to be performed in advance by the user, the administrator, or the like. This setting may be in common with all orders. Alternatively, the setting may be performed for each order at each time of input of the order. When an automatic market order is not to be placed (NO at S93), the control unit 10 acquires the profit taking prices and the loss cut prices from the clearing order serving as the processing object and from a clearing order to which the same parent order number as the clearing order serving as the processing object is imparted (S94). The control unit 10 acquires the set-forth time (S95). The set-forth time is premised to be set forth in advance. The set-forth time may be set forth by the user at the time of placing the order, or alternatively may be the same as the term of validity of the order. Further, the set-forth time may be the same as the range of the data of real-time pivot (the specified range). When rapid clearing is desired, the set-forth time is set to be shorter than the term of validity of the order or the range of the data. For example, one third the term of validity of the order or one third the range of the data is adopted as the set-forth time. The control unit 10 calculates the update width (the addition value) for the loss cut price from the difference value between the profit taking price and the loss cut price and from the set-forth time, and then updates the loss cut price (S96). For example, in a case that the loss cut price is 79.371 and the profit taking price is 78.557 and that the set-forth time is 24 hours, when a value of −0.034 (=(78.557−79.371)/24; rounded off at the fourth decimal place) is added to the loss cut price at every hour, the loss cut price reaches 78.555 after 24 hours and hence exceeds the profit taking price. The control unit 10 judges whether contract has been established for the loss cut order whose price has been updated (S97). When contract is not yet established (NO at S97), the control unit 10 returns the processing to S96. When contract has been established (YES at S97), the control unit 10 places a repeat order (S98) and then terminates the processing. In this example, once the loss cut price is updated (S96), whether contract has been established is judged immediately (S97). However, the judgment may be preferred after a predetermined time has elapsed since the update. In the example described above, in a case that clearing is not yet established even after 1 hour, the loss cut price is updated. Here, in the example described above, the update width for the loss cut price has been a value obtained when the difference value between the profit taking price and the loss cut price is equally divided by the number of hours in the set-forth time. However, employable configurations are not limited to this. This is because in a case that the volatility (the rate of price fluctuation) is high, the approach of adding the equally divided value could cause a long time until contract is established and could prevent rapid clearing of the position.

Further, a plurality of methods of calculating the update width for the loss cut price may be prepared. Then, the user may select one at the time of placing an order, or alternatively at the time that update processing for the loss cut price is started, the control unit 10 may select a calculation method depending on the magnitude of the volatility.

An example is described below that in the loss cut price and the profit taking price, the addition value is increased as time progresses by using the Fibonacci numbers. The set-forth time is premised to be 12 hours. The loss cut price is 79.371 and the profit taking price is 78.557. Utilized here are the first 12 numbers in the Fibonacci sequence, that is, 1, 1, 2, 3, 5, 8, 13, 21, 34, 55, 89, and 144. The total of these 12 numbers is 376. Values obtained when the difference value (−0.814) between the profit taking price and the loss cut price is divided by 376 and then the result (−0.00216) is multiplied by the values (1, 1, 2, . . . ) in the Fibonacci sequence may be adopted as the update widths to be added to the loss cut price. The obtained update widths are −0.00216, −0.00216, −0.00432, . . . , −0.1188, −0.19224, −0.31104. Then, the updated loss cut prices are 79.369, 79.367, 79.362, . . . , 79.062, 78.870, 78.559. Here, since the calculation result for the initial update width has been rounded off at the sixth decimal place so that −0.00216 has been adopted, the last price does not reach the profit taking price. In order that the profit taking price should be reached reliably, rounding-up may be adopted.

When an automatic market order is to be placed (YES at S93), the control unit 10 cancels the clearing order serving as the processing object and a clearing order to which the same parent order number as the clearing order serving as the processing object is imparted (S99). The control unit 10 places a market order corresponding to the canceled clearing order (S100). The control unit 10 judges whether contract has been established (S101). When contract is not yet established (NO at S101), the control unit 10 performs the process of S101 again. When contract has been established (YES at S101), the control unit 10 places a repeat order (S98) and then terminates the processing.

The repeat order processing indicates that an order similar to an IFO order composed of the fresh order, the profit taking order, and the loss cut order corresponded to the cleared position is performed automatically. That is, the pivot value is calculated with adopting a similar set-forth period for the data used in calculation of the real-time pivot value as well as a similar specified range for the data. With adopting similar correspondence relations between the index value and the prices, the order price, the profit taking price, and the loss cut price are determined. And then, a new order is placed. Detailed processing is similar to the price update processing illustrated in FIG. 24, and hence its flow chart is omitted.

In addition to the effects obtained by the index value calculation apparatus 1 according to Embodiments 1 to 4, the index value calculation apparatus 1 according to Embodiment 5 has the following effects.

In addition to an effect that an order whose term of validity has elapsed is canceled, the price of a fresh orders is updated by using the newest pivot value so that contract is easily established for the fresh order. In case of a clearing order, the loss cut price is progressively brought close to the profit taking price. This permits clearing at a smaller loss.

In the above-mentioned Embodiment 5, the index value calculation apparatus 1 has performed the processing of order update or cancellation on the basis of the term of validity. However, employable configurations are not limited to this. For example, the function of the index value calculation apparatus 1 may be imparted to the financial product transaction management apparatus 2 and then the user may use a general-purpose terminal.

From the aspect of capital turnover efficiency, it is preferable that an order whose term of validity has elapsed is rapidly updated, canceled, or the like. In a case that the index value calculation apparatus 1 is realized by a user terminal, when the user terminal serving as the index value calculation apparatus 1 is always operating, such an order whose term of validity has elapsed is rapidly updated or canceled. Nevertheless, when the user terminal serving as the index value calculation apparatus 1 is not operating, the order whose term of validity has elapsed is neither updated nor canceled.

Further, the master data of the order data table Tb2, the position data table Tb3, and the contract history table Tb4 described above is stored in the mass storage device 23 of the financial product transaction management apparatus 2. Then, the data stored in the mass storage device 13 of the index value calculation apparatus 1 is synchronized with the data stored in the financial product transaction management apparatus 2.

The above-mentioned pivot formula is based on the so-called standard formula (the classic formula). Nevertheless, the present technique is not limited to the standard formula. That is, the calculation formula for the real-time pivot value may be constructed from the Fibonacci formula, the Camarilla formula, the Woodie formula, or the DeMark formula. The method of constructing the formula is similar to that of the case of standard formula. That is, the following replacement may be performed. The high price of the preceding day is replaced by the high price in the specified range. The low price of the preceding day is replaced by the low price in the specified range. The closing price of the preceding day is replaced by the present price. For example, in the case that the Fibonacci formula is used, the result is obtained as follows.

P=(H+L+PR)/3 (Formula A)

R3=P+1.000×(H−L) (Formula 1)

R2=P+0.618×(H−L) (Formula 2)

R1=P+0.382×(H−L) (Formula 3)

S1=P−0.382×(H−L) (Formula 4)

S2=P−0.618×(H−L) (Formula 5)

S3=P−1.000×(H−L) (Formula 6)

where

H: high price in the specified range

L: low price in the specified range

PR: present price

P: pivot value

R1 to R3: resistance lines 1 to 3

S1 to S3: support lines 1 to 3

These formulas are similar to the standard calculation formulas for the pivot value P, and hence designated by like formula numbers. Here, the coefficients multiplied to (H−L) when the resistance lines 1 to 3 and the support lines 1 to 3 are calculated are exemplary ones. That is, employable combinations are not limited to (0.382, 0.618, 1.000) given above, and another combination of values may be employed. In this case, one coefficient alone may be changed into another value, or alternatively all coefficients may be changed into other values.

Further, the auxiliary lines M0 to M5 described in Embodiment 1 may be added.

In the case that the Camarilla formula is used, the result is obtained as follows. The meanings of the individual variables are similar to those given above.

P=(H+L+PR)/3 (Formula A)

R4=(H−L)×1.1/2+PR (Formula 7)

R3=(H−L)×1.1/4+PR (Formula 8)

R2=(H−L)×1.1/6+PR (Formula 9)

R1(H−L)×1.1/12+PR (Formula 10)

S1=PR−(H−L)×1.1/12 (Formula 11)

S2=PR−(H−L)×1.1/6 (Formula 12)

S3=PR−(H−L)×1.1/4 (Formula 13)

S4=PR−(H−L)×1.1/2 (Formula 14)

These formulas are similar to the standard calculation formulas for the pivot value P, and hence designated by like formula numbers. In the Camarilla formula, the resistance line 4 (R4) and the support line 4 (S4) are added. Further, the auxiliary lines M0 to M5 described in Embodiment 1 may be added. Constants employable in Formulas 7 to 14 are not limited to those given above, and other values may be employed.

In case of the Woodie formula, the result is obtained as follows. The meanings of the individual variables are similar to those given above.

P=(H+2×PR+L)/4 (Formula 15)

R1=2P−L (Formula B)

R2=P−L+H (Formula C)

S1=2P−H (Formula E)

S2=P−H+L (Formula F)

In the Woodie formula, two resistance lines and two support lines are employed. Further, their calculation formulas are the same as those of the standard formula, and hence designated by like formula numbers.

The auxiliary lines are similar to those of the standard formula. However, since R3 and S3 are not calculated, M1 to M4 may be adopted as the auxiliary lines.

In the case that the DeMark formula is used, the result is obtained as follows. The meanings of the individual variables are similar to those given above. In the DeMark formula, the opening price O is used. In contrast, in the real-time pivot formula, the undetermined opening price of the newest historical data is used as the opening price.

(a) In Case of O>PR (Negative Candle)

X=O+H+PR+L (Formula 16)

(b) In Case of O<PR (Positive Candle)

X=O+H+PR+H (Formula 17)

(c) In Case of O=PR (Identical Price)

X=O+H+PR+PR (Formula 18)

By using X calculated according to the formula given above, the resistance line R and the support line S are calculated.

R=X/2−L (Formula 19)

S=X/2−H (Formula 20)

As described above, in addition to the standard formula, various kinds of pivot formulas like the Fibonacci formula, the Camarilla formula, the Woodie formula, and the DeMark formula are allowed to have real-time nature. The user may select one of these pivot formulas and then place an order. In this case, the selection may be performed in the technical mode specification area 31i in the ordering screen (FIG. 17) of Embodiment 2. Similarly, initial setting may be performed in the initial technical mode setting area 33a in the setting screen (FIG. 19) of Embodiment 3.

In the above-mentioned embodiments, description has been given for a case that the real-time pivot technique is utilized in the case of an IFO order. However, employable applications are not limited to this. In addition to various kinds of ordering methods, the real-time pivot technique may be applied to situations of determining order prices. For example, the pivot technique may be used in a case that a fresh limit order is to be placed or alternatively in a case that a clearing limit order is to be placed for a position in which a clearing order has not yet been placed. Further, the pivot technique may be applied to a case that two IFO orders are to be combined with each other so that a fresh order in the form of an OCO order is to be generated.

Here, in the above-mentioned embodiments, the transaction object has been a financial product, especially, a foreign exchange. However, employable transaction objects are not limited to this. That is, other financial products such as stocks and investment funds may be employed. Alternatively, in place of such financial products, commodities such as gold, grains, and oils dealt with in the markets may be employed.

The technical features (the constituent features) described in the individual embodiments may be combined with each other. Such combinations may form new technical features.

As this invention may be embodied in several forms without departing from the spirit of essential characteristics thereof, the present embodiment is therefore illustrative and not restrictive, since the scope of the invention is set forth by the appended claims rather than by the description preceding them, and all changes that fall within metes and bounds of the claims, or equivalence of such metes and bounds thereof are therefore intended to be embraced by the claims.

What is claimed is:

1. A non-transitory computer-readable recording medium in which a computer program for causing a computer to calculate an index value indicating a trend in the transaction price of a product is recorded, the computer program causing the computer to perform steps of:
on the basis of a time of day, a unit period in which a high price and a low price of transaction price of the product are to be calculated, and a calculation period containing a plurality of consecutive unit periods, setting forth an acquisition period for data to be used for calculating the index value indicating the trend in the transaction price;
from a historical data storage part storing, historical data in which for each unit period, a high price and a low price of transaction price are related to a start time or an end time of the unit period, reading out historical data contained in the set-forth acquisition period;
identifying the lowest price and the highest price of transaction price from the read-out historical data;
acquiring a transaction price at predetermined time intervals;
at each time of acquiring the transaction price, on the basis of the acquired transaction price and the identified lowest and highest prices, updating the lowest price or the highest price of transaction price; and
on the basis of the updated one of the lowest price and the highest price, the other one not updated, and the acquired transaction price, calculating the index value.

2. The recording medium according to claim 1,
wherein the computer program causes the computer to perform steps of:
acquiring a time of day together with the transaction price and then, when the acquired time of day is not contained in the acquisition period, updating the acquisition period;
reading out historical data contained in the updated acquisition period;
identifying the lowest price and the highest price of transaction price from the read-out historical data; and
calculating the index value.

3. The recording medium according to claim 1,
wherein the computer program causes the computer to perform a step of
calculating the index value P according to the following Formula A.
P=(H+L+PR)/3 (Formula A)
where
PR: transaction price
H: highest price
L: lowest price

4. A non-transitory computer-readable recording medium in which the computer program of claim 1 is recorded and in which an order data generating program for causing a computer to generate an order data for a product is recorded, the order data generating program causing the computer to perform steps of:
calculating the index value P according to the following Formula A;
by using the calculated index value P according to following Formulas B, C, D, E, F, and G, calculating resistance lines R1, R2, and R3 and support lines S1, S2, and S3; and
generating fresh order data, profit taking order data, and loss cut order data for the product containing as prices three values selected from R1, R2, R3, S1, S2, S3 and the index value P which have been obtained by calculation.
P=(H+L+PR)/3 (Formula A)
R1=2P−L (Formula B)
R2=P−L+H (Formula C)
R3=2P−2L+H (Formula D)
S1=2P−H (Formula E)
S2=P−H+L (Formula F)
S3=2P−2H+L (Formula G)
where
PR: transaction price
H: highest price
L: lowest price
R1: resistance line 1
R2: resistance line 2
R3: resistance line 3
S1: support line 1
S2: support line 2
S3: support line 3

5. The recording medium according to claim 4,
wherein the order data generating program causes the computer to perform steps of:
for each unit period, reading out the P, R1, R2, R3, S1, S2, and S3 from an index value storage part storing, the P, R1, R2, R3, S1, S2, and S3 in a manner of being related to a start time or an end time of the unit period, and then outputting an image in which the read-out P, R1, R2, R3, S1, S2, S3, an order price contained in an ordinary order, a profit taking price contained in the profit taking order, and a loss cut price contained in the loss cut order are displayed in two-dimensional coordinates;
receiving on the image an operation of changing at least one of the order price, the profit taking price, and the loss cut price; and
generating fresh order data, profit taking order data, and loss cut order data in which the received contents of changing the price are reflected.

6. The recording medium according to claim 4,
wherein the order data generating program causes the computer to perform steps of:
receiving an instruction of confirming the fresh order data, the profit taking order data, and the loss cut order data having been generated;
imparting an order number to the fresh order data;
storing into an order data storage part the fresh order data as well as the profit taking order data and the loss cut order data related to the fresh order data by using the order number;
storing an ordering pattern indicating a correspondence relation of the P, R1, R2, R3, S1, S2, and S3 used when the fresh order data as well as the profit taking order data and the loss cut order data related to the fresh order data are generated to the order price, the profit taking price, and the loss cut price, into an ordering pattern storage part in a manner of being related to the order number;
reading out fresh order data from the order data storage part;
at each time of acquiring the transaction price, judging whether contract has been established for the read-out fresh order data;
when establishment of the contract has been concluded, generating position data on the basis of the fresh order data whose contract has been established and then storing into a position storage part the position data in a manner of being related to the order number of the fresh order data whose contract has been established;
reading out profit taking order data or loss cut order data from the order data storage part;
at each time of acquiring the transaction price, judging whether contract has been established for the profit taking order data or the loss cut order data having been read out;
when establishment of the contract has been concluded, on the basis of the order number related to the profit taking order data or the loss cut order data whose contract has been established, reading out position data related to the order number from the position storage part;
on the basis of the order number related to the read-out position data, reading out from the ordering pattern storage part an ordering pattern related to the order number; and
in accordance with the read-out ordering pattern, generating new fresh order data as well as profit taking order data and loss cut order data related to the fresh order data.

7. The recording medium according to claim 4,
wherein the fresh order data contains a term of validity, and
wherein the order data generating program causes the computer to perform steps of:
when the term of validity of the fresh order data stored in the order data storage part has elapsed, reading out from the order data storage part the fresh order data whose term of validity has elapsed and the profit taking order data and the loss cut order data related to the fresh order data; and
on the basis of the order number of the read-out fresh order data, reading out an ordering pattern from the ordering pattern storage part and then, in accordance with the read-out ordering pattern, updating the read-out fresh order data as well as the profit taking order data and the loss cut order data related to the fresh order data.

8. The recording medium according to claim 4,
wherein the fresh order data contains a term of validity, and
wherein the order data generating program causes the computer to perform a step of
when the term of validity of the fresh order data stored in the order data storage part has elapsed, deleting from the order data storage part the fresh order data whose term of validity has elapsed and the profit taking order data and the loss cut order data related to the fresh order data.

9. The recording medium according to claim 6,
wherein the position data contains a term of validity, and
wherein the order data generating program causes the computer to perform a step of
when the term of validity of the position data stored in the position storage part has elapsed, generating a market order for clearing the position data whose term of validity has elapsed.

10. The recording medium according to claim 6,
wherein the position data contains a term of validity, and
wherein the order data generating program causes the computer to perform steps of:
when the term of validity of the position data stored in the position storage part has elapsed, on the basis of the order number related to the position data whose term of validity has elapsed, reading out the profit taking order data and the loss cut order data from the order data storage part and then acquiring a profit taking price contained in the read-out profit taking order data and a loss cut price contained in the read-out loss cut order data; and
calculating a difference between the profit taking price and the loss cut price having been acquired, then setting forth an addition value on the basis of the calculated difference, and then, for each predetermined time interval, updating the loss cut order data with adopting as a new loss cut price the price obtained by adding the set-forth addition value to the loss cut price.

11. An index value calculation method of calculating an index value indicating a trend in the transaction price of a product, comprising steps of:
on the basis of a time of day, a unit period in which a high price and a low price of transaction price of the product are to be calculated, and a calculation period containing a plurality of consecutive unit periods, setting forth in advance an acquisition period for data to be used for calculating the index value indicating the trend in the transaction price;
from a historical data storage part storing, historical data in which for each unit period, a high price and a low price of transaction price are related to a start time or an end time of the unit period, reading out, in advance, historical data contained in the set-forth acquisition period;
identifying in advance the lowest price and the highest price of transaction price from the read-out historical data acquiring a transaction price at predetermined time intervals;
at each time of acquiring the transaction price, on the basis of the acquired transaction price and the identified lowest and highest prices, updating the lowest price or the highest price of transaction price; and
on the basis of the updated one of the lowest price and the highest price, the other one not updated, and the acquired transaction price, calculating the index value.

12. An index value calculation apparatus calculating an index value indicating a trend in the transaction price of a product, comprising:
an acquisition period determination part, on the basis of a time of day, a unit period in which a high price and a low price of transaction price of the product are to be calculated, and a calculation period containing a plurality of consecutive unit periods, configured to set forth an acquisition period for data to be used for calculating the index value indicating the trend in the transaction price;
a historical data acquisition part, from a historical data storage part storing, historical data in which for each unit period, a high price and a low price of transaction price are related to a start time or an end time of the unit period, configured to read out historical data contained in the set-forth acquisition period;
a highest price and lowest price identification part configured to identify the lowest price and the highest price of transaction price from the read-out historical data;
a price acquisition part configured to acquire a transaction price at predetermined time intervals;
an updating part, at each time of acquiring the transaction price, on the basis of the acquired transaction price and the identified lowest and highest prices, configured to update the lowest price or the highest price of transaction price; and
a calculation part, on the basis of the updated one of the lowest price and the highest price, the other one not updated, and the acquired transaction price, configured to calculate the index value.
